(19) United States
(12) Patent Application Publication
(10) Pub. No.: US 2014/0089619 A1
(43) Pub. Date: Mar. 27, 2014

(54) OBJECT REPLICATION FRAMEWORK FOR A DISTRIBUTED COMPUTING ENVIRONMENT

(71) Applicant: INFINERA CORPORATION, Sunnyvale, CA (US)

(72) Inventors: Vinay KHANNA, Bangalore (IN); Mohit Misra, Bangalore (IN); Ashok Kunjidhapatham, Bangalore (IN); Biao Lu, Cupertino, CA (US); Khuzema Pithewan, Bangalore (IN)

(73) Assignee: Infinera Corporation, Sunnyvale, CA (US)

(21) Appl. No.: 13/629,191

(22) Filed: Sep. 27, 2012

(51) Int. Cl. G06F 3/06

(52) U.S. Cl. CPC G06F 3/0652
USPC 711/166

(57) ABSTRACT

A device may receive information that identifies a data item and a data item operation. The device may store a first sequence identifier, a data item reference that references the data item, and an operation reference that references the operation. The first sequence identifier may reference the data item and operation references, and may indicate an order in which the first sequence identifier is stored. The device may store the data item in a memory location, may store an identification of the memory location, may remove a reference to the data item by a previous sequence identifier, and/or may add the data item, may modify the data item, or may delete the data item depending on whether the operation is an add operation, a modify operation, or a delete operation. The device may transmit, to a slave device, the first sequence identifier, the data item reference, and the operation reference.

### BACKGROUND

A distributed computing environment may include multiple autonomous or semi-autonomous computing devices (e.g., servers, computers, etc.) that communicate with one another through a computer network. The computing device in the distributed computing environment may each have a local memory, and may communicate by passing messages.

### SUMMARY

A device may receive information that identifies a data item and an operation to perform on the data item. The device may store a first sequence identifier, a data item reference that references the data item, and an operation reference that references the operation. The first sequence identifier may reference the data item and operation references, and may indicate an order in which the first sequence identifier is stored. The device may store the data item in a memory location, may store an identification of the memory location, may remove a reference to the data item by a previous sequence identifier, and/or may add the data item, may modify the data item, or may delete the data item depending on whether the operation is an add operation, a modify operation, or a delete operation. The device may transmit, to a slave device, the first sequence identifier, the data item reference, and the operation reference.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a diagram of example functional components of a master device of FIG. 2;

FIG. 5 is a diagram of an example process for updating a data set;

FIG. 6 is a diagram of an example data structure that stores data item information;

FIG. 7 is a diagram of an example implementation relating to the process illustrated in FIG. 5;

FIG. 8 is a diagram of an example process for aggregating and publishing data item updates;

FIG. 9 is a diagram of an example implementation relating to the process illustrated in FIG. 8;

FIG. 10 is a diagram of an example process for responding to requests from slave devices;

FIG. 11 is a diagram of an example implementation relating to the process illustrated in FIG. 10;

FIG. 12 is a diagram of example functional components of a slave device of FIG. 2;

FIG. 13 is a diagram of an example process for requesting a missing data item update;

FIG. 14 is a diagram of an example implementation relating to the process illustrated in FIG. 13;

FIG. 15 is a diagram of an example process for handling stale data item updates;

FIGS. 16A and 16B are diagrams of an example implementation relating to the process illustrated in FIG. 15; and

FIG. 17 is a diagram of example states and state transitions of one or more devices of FIG. 2.

### DETAILED DESCRIPTION

The following detailed description of example implementations refers to the accompanying drawings. The same reference numbers in different drawings may identify the same or similar elements.

In a distributed computing environment where each computer has a local memory, it may be desirable to synchronize the computers so that each local memory is updated with current information. For example, computers in a distributed computing environment may act as nodes in a network, such as a telecommunications network, and each node may be responsible for routing traffic through the network. In order to route traffic efficiently, each node should be updated with current network information, such as available bandwidth at other nodes, available bandwidth on links (e.g., optical fibers) that connect nodes, and other routing information.

A distributed computing environment may include master devices responsible for receiving current information, storing the current information, and communicating the current information to slave devices. Implementations described herein may assist in synchronizing devices in a distributed computing environment (such as master devices and slave devices) so that a local memory of each device stores current information.

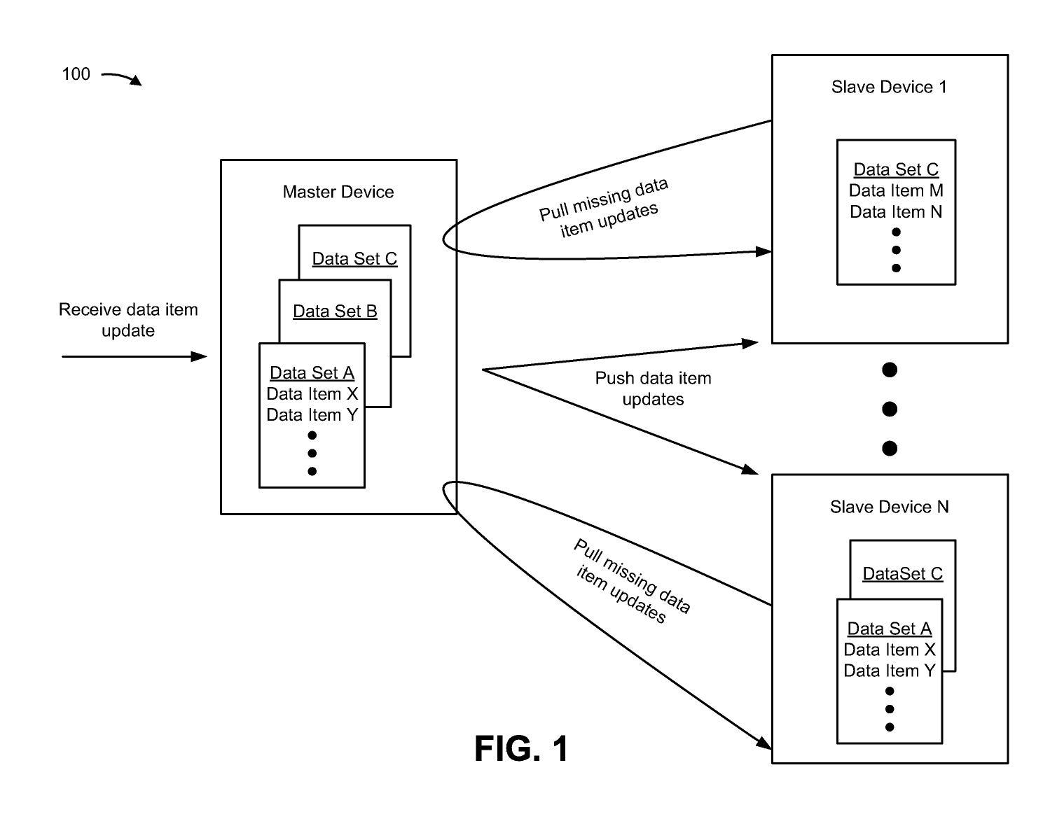

FIG. 1 is a diagram of an overview 100 of an example implementation described herein. As shown in FIG. 1, a distributed computing environment may include a master device and one or more slave devices. For example, the master device may be a server, and the slave devices may be computing nodes in a distributed computing environment.

As illustrated in FIG. 1, the master device may store one or more data sets in memory. Each data set may include one or more data items. The master device may receive an update to a data item (e.g., a new data item, a modification to a data item, a deletion of a data item, etc.), and may push the data item update to the slave devices. The slave devices may also store data sets in memory. In some implementations, a slave device may store a subset of the data sets stored by the master device. For example, the master device may store data sets A, B, and C, as illustrated. A slave device may store all of the data sets stored by the master device, or the slave device may store a subset of the data sets stored by the master device. As illustrated, slave device 1 may store data set C, and slave device N may store data sets A and C.

In some embodiments, the master device may push a data item update to slave devices that store the data set to which the data item update belongs. For example, an update to a data item included in data set A may be pushed to slave device N, but not to slave device 1. As used herein, “pushing” information may refer to sending information to a slave device, from the master device, without receiving a request for the information from the slave device.

Additionally, or alternatively, a slave device may identify a data item that is missing from a data set stored on the slave device. The slave device may pull the missing data item from the master device. As used herein, “pulling” information may refer to sending information to a slave device, from the master device, after receiving a request for the information from the slave device.

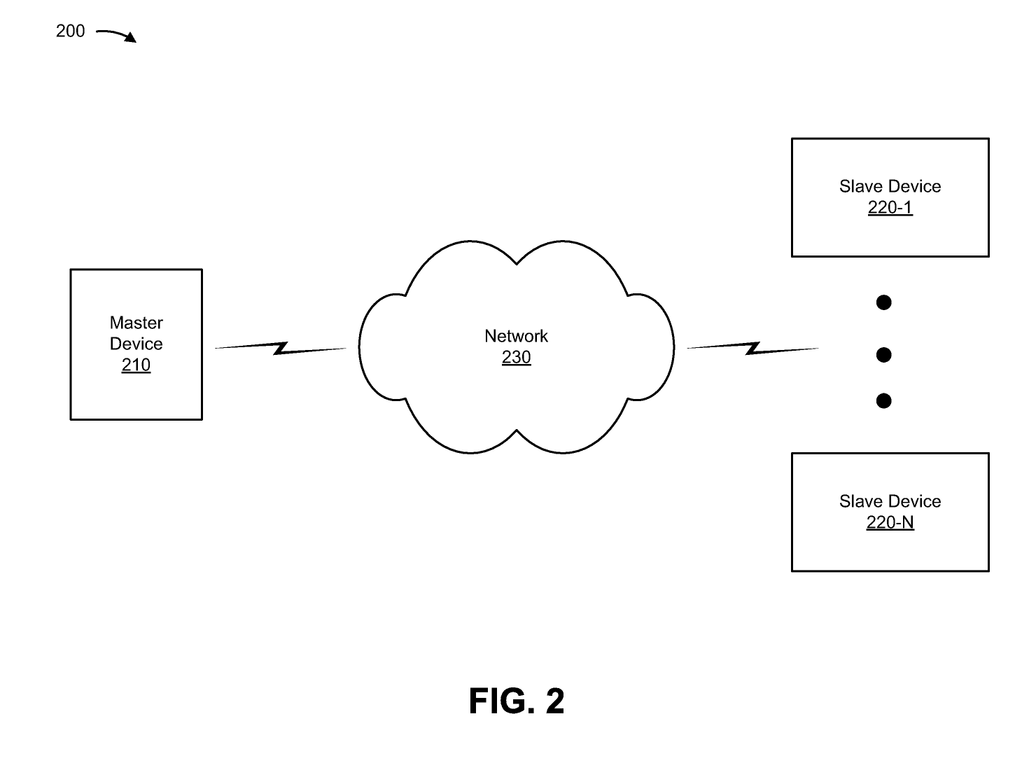

FIG. 2 is a diagram of an example environment 200 in which systems and/or methods described herein may be implemented. As illustrated in FIG. 2, environment 200 may include a master device 210, a set of slave devices 220-1 through 220-N (N≧1) (hereinafter referred to collectively as “slave devices 220,” and individually as “slave device 220), and a network 230.

Master device 210 may include one or more computation and communication devices, such as a server. In some implementations, master device 210 may be a computing device included in a distributed computing environment, such as a computing node, a hub, a bridge, a gateway, a router, a modem, a switch, a firewall, a server, an optical add/drop multiplexer (“OADM”), or another type of device in a distributed computing environment. In some implementations, master device 210 may process, route, and/or transfer traffic through a distributed computing environment. Additionally, or alternatively, master device 210 may receive information (e.g., information regarding the distributed computing environment), may store the information, and may communicate the information to slave devices 220 via network 230. Master device 220 may receive the information from a user, an application, and/or another device.

Slave device 220 may include a computation and communication device included in a distributed computing environment, such as a computing node, a hub, a bridge, a gateway, a router, a modem, a switch, a firewall, a server, an optical add/drop multiplexer (“OADM”), or another type of device included in a distributed computing environment. In some implementations, slave device 220 may process, route, and/or transfer traffic through a distributed computing environment. Additionally, or alternatively, slave device 220 may request information from master device 210 (e.g., via network 230), and may receive a response to the request from master device 210 (e.g., via network 230). In some implementations, slave device 220 may include one or more master devices 210. In other words, slave device 220 may be capable of performing the functions of master device 210 for other slave devices 220.

Network 230 may include one or more wired and/or wireless networks. For example, network 230 may include a cellular network, a radio access network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

The number of devices and/or networks illustrated in FIG. 2 is provided for explanatory purposes. In practice, environment 200 may include additional devices and/or networks, fewer devices and/or networks, different devices and/or networks, or differently arranged devices and/or networks than those illustrated in FIG. 2. For example, environment 200 may include multiple master devices 210. Furthermore, two or more of the devices illustrated in FIG. 2 may be implemented within a single device, or a single device illustrated in FIG. 2 may be implemented as multiple, distributed devices. Additionally, or alternatively, one or more of the devices of environment 200 may perform one or more functions described as being performed by another one or more of the devices of environment 200.

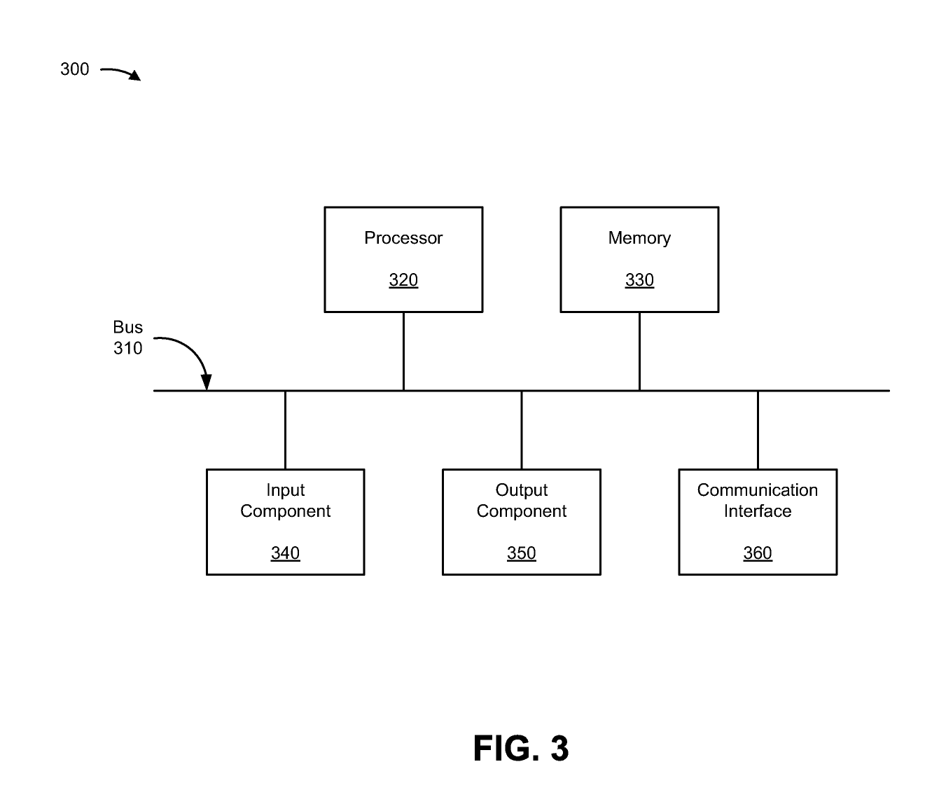

FIG. 3 is a diagram of example components of a device 300. Device 300 may correspond to master device 210 and/or slave device 220. As illustrated in FIG. 3, device 300 may include a bus 310, a processor 320, a memory 330, an input component 340, an output component 350, and a communication interface 360.

Bus 310 may include a path that permits communication among the components of device 300. Processor 320 may include a processor, a microprocessor, and/or any processing logic (e.g., a field-programmable gate array (“FPGA”), an application-specific integrated circuit (“ASIC”), etc.) that interprets and/or executes instructions. In some implementations, processor 320 may include one or more processor cores. Memory 330 may include a random access memory (“RAM”), a read only memory (“ROM”), and/or any type of dynamic or static storage device (e.g., a flash, magnetic, or optical memory) that stores information and/or instructions for use by processor 320.

Input component 340 may include any mechanism that permits a user to input information to device 300 (e.g., a keyboard, a keypad, a mouse, a button, a switch, etc.). Output component 350 may include any mechanism that outputs information from device 300 (e.g., a display, a speaker, one or more light-emitting diodes (“LEDs”), etc.).

Communication interface 360 may include any transceiver-like mechanism, such as a transceiver and/or a separate receiver and transmitter, that enables device 300 to communicate with other devices and/or systems, such as via a wired connection, a wireless connection, or a combination of wired and wireless connections. For example, communication interface 360 may include a mechanism for communicating with another device and/or system via a network. Additionally, or alternatively, communication interface 360 may include a logical component with input and output ports, input and output systems, and/or other input and output components that facilitate the transmission of data to and/or from another device, such as an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include space within a single storage device or space spread across multiple storage devices.

Software instructions may be read into memory 330 from another computer-readable medium or from another device via communication interface 360. When executed, software instructions stored in memory 330 may cause processor 320 to perform one or more processes that are described herein. Additionally, or alternatively, hardwired circuitry may be used in place of or in combination with software instructions to perform one or more processes described herein. Thus, implementations described herein are not limited to any specific combination of hardware circuitry and software.

The number of components illustrated in FIG. 3 is provided for explanatory purposes. In practice, device 300 may include additional components, fewer components, different components, or differently arranged components than those illustrated in FIG. 3. Additionally, or alternatively, each of master device 210 and/or slave device 220 may include one or more devices 300 and/or one or more components of device 300.

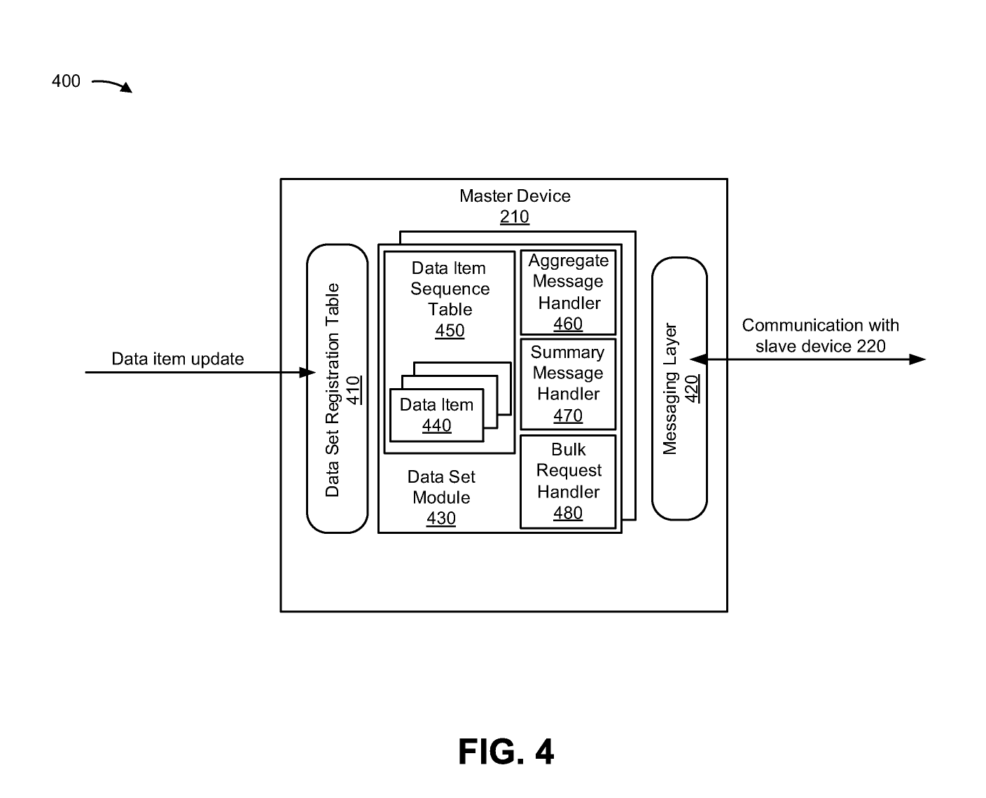

FIG. 4 is a diagram of example functional components of a device 400 that may correspond to master device 210 in some implementations. In another implementation, one or more of the example functional components of device 400 may be implemented by another device or a collection of devices including or excluding master device 210. As illustrated, device 400 may include a data set registration table 410, a messaging layer 420, and a data set module 430. Data set module 430 may include a data item sequence table 450, an aggregate message handler 460, a summary message handler 470, and a bulk request handler 480. Data item sequence table 450 may contain one or more data items 440.

Data set registration table 410 may perform operations associated with creating and managing data sets. In some implementations, data set registration table 410 may register a data set by storing the data set in memory and assigning a data set identifier (e.g., a number, an integer, a letter, etc.) to the data set. For example, data set registration table 410 may receive a registration request for a data set to be stored on master device 210 and to be replicated on slave devices 220, and may register the data set based on the registration request. Data set registration table 410 may also unregister a data set by removing the data set from memory. Additionally, or alternatively, data set registration table 410 may update a data set by adding, modifying, or deleting a data item 440 in the data set. In some implementations, data set registration table 410 may enable or disable access to a data set. For example, data set registration table 410 may disable communication of information stored in a data set to slave device 220 when the data set is being updated (e.g., when a data item is being added to, modified, or deleted from the data set). In some implementations, data set registration table 410 may receive information identifying a command, and may manage a data set based on the command.

Messaging layer 420 may perform operations associated with communicating with slave device 220. For example, messaging layer 420 may enable slave device 220 to be aware of master device 210, and to communicate with master device 210. In some implementations, messaging layer 420 may push data items to slave device 220 via multicasting. For example, each slave device that stores a particular set of data sets may be registered with a particular multicast address. Master device 210 may publish updates to the particular set of data sets using the particular multicast address as a destination for the updates. Additionally, or alternatively, messaging layer 420 may receive a pull request from a slave device 220, and may send a data item to slave device 220 via a unicast address in response to the pull request.

Data set module 430 may perform operations associated with maintaining and publishing data sets. In some implementations, data set module 430 may store data items 440. Data item 440 may include content and/or records that are to be replicated. As used herein, “data item information” may refer to information associated with data item 440. In some implementations, data set module 430 may store data item information in data item sequence table 450. As used herein, a “data item update” may refer to data item 440 and/or data item information. In some implementations, data set module 430 may manage publication (e.g., pushing and pulling) of data item updates via aggregate message handler 460, summary message handler 470, and/or bulk request handler 480. In some implementations, master device 210 may include multiple data set modules 430, one for each data set stored by master device 210. Additionally, or alternatively, a single data set module 430 may manage multiple data sets stored by master device 210.

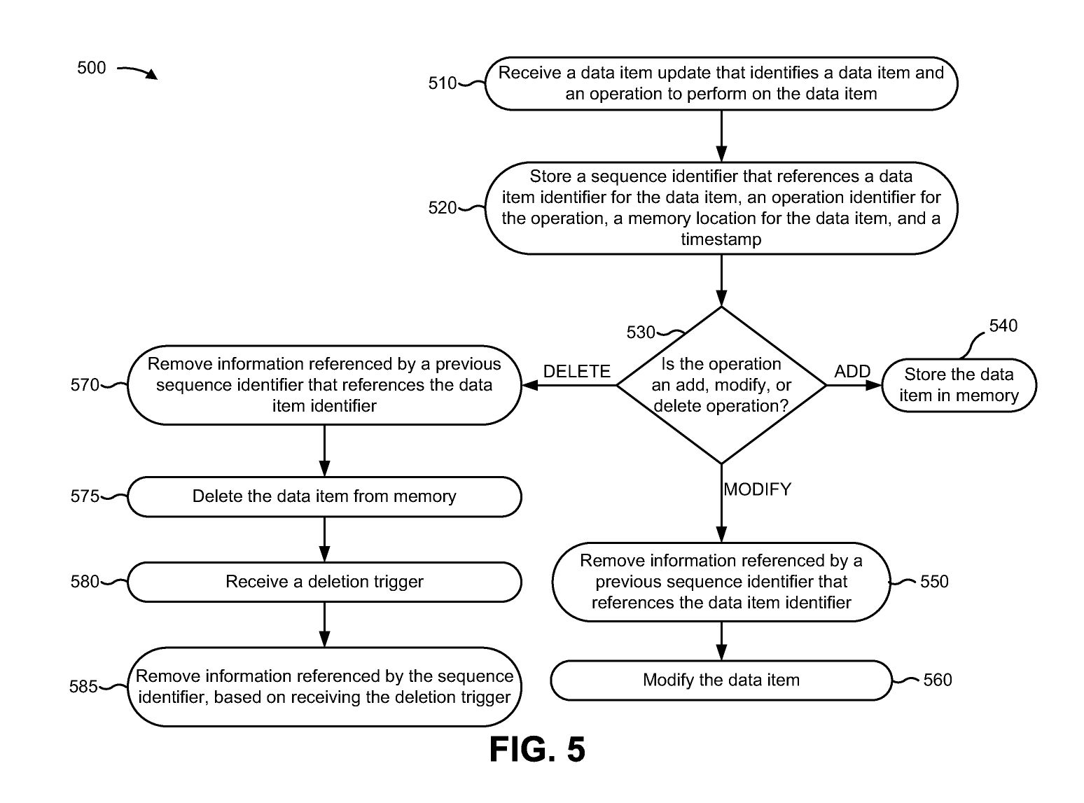

Data item sequence table 450 may store data item information. In some implementations, data item sequence table 450 may assign a sequence identifier to each data item update stored in a data set. For example, the sequence identifier may identify a data item 440, an operation (e.g., add, modify, delete) to be performed on data item 440, and/or other information, discussed in more detail in connection with FIGS. 5-7. The sequence identifier may identify an order in which data item updates are received, processed, and/or stored by master device 210.

Aggregate message handler 460 may perform operations associated with pushing data item updates from master device 210 to slave device 220. In some implementations, aggregate message handler 460 may determine which data item updates to push to slave devices 220, and may push the determined data item updates to slave devices 220 based on a publication trigger. For example, the publication trigger may include a quantity of unpublished data item updates satisfying a threshold; a quantity of slave devices 220, capable of receiving the data item updates, satisfying a threshold; and/or an expiration of a publication timer.

Summary message handler 470 may perform operations associated with notifying slave devices 220 of data item updates. For example, summary message handler 470 may periodically transmit a summary message to slave device 220 that contains an indication of most recent publication (e.g., an indication of a most recently published data item update, such as a sequence identifier that references the data item update). Slave device 220 may use the indication to determine whether slave device 220 is synchronized with the most recent data item update (e.g., whether the data sets stored on slave device 220 match the corresponding data sets stored on master device 210).

Bulk request handler 480 may perform operations associated with responding to pull requests from slave devices 220. For example, bulk request handler 480 may receive a pull request, from slave device 220, that indicates a data item update that is missing from a memory of slave device 220. Bulk request handler 480 may transmit the missing data item update to slave device 220.

The number of functional components illustrated in FIG. 4 is provided for explanatory purposes. In practice, device 400 may include additional functional components, fewer functional components, different functional components, or differently arranged functional components than those illustrated in FIG. 4. Functional components 410-480 may be implemented using one or more devices 300 and/or one or more components of device 300. Master device 210 may individually include all of the functional components depicted in FIG. 4, or the functional components depicted in FIG. 4 may be distributed singularly or duplicatively in any manner between the devices illustrated in FIG. 2.

FIG. 5 is a diagram of an example process 500 for updating a data set. In some implementations, one or more process blocks of FIG. 5 may be performed by one or more components of master device 210. Additionally, or alternatively, one or more process blocks of FIG. 5 may be performed by one or more components of another device or a collection of devices including or excluding master device 210.

As illustrated in FIG. 5, process 500 may include receiving a data item update that identifies a data item and an operation to perform on the data item (block 510). In some implementations, the data item update may include data item 440. For example, master device 210 may receive an indication to add data item 440 to memory. Additionally, or alternatively, master device 210 may receive an indication to modify data item 440 already stored in memory, and/or to delete data item 440 already stored in memory. Master device 210 may receive the indication (e.g., the data item update) from a user, an application, and/or another device.

As further illustrated in FIG. 5, process 500 may include storing a sequence identifier that references a data item identifier for the data item, an operation identifier for the operation, a memory reference for the data item, and a timestamp (block 520). The data item identifier, the operation identifier, the memory reference, and the timestamp may be referred to herein as “data item information.” Master device 210 may store the data item information. The data item information may also include a sequence identifier that indicates an order in which a data item update is received, processed, and/or stored by master device 210. For example, the sequence identifier may include a number, and a higher number may indicate a more recent data item update than a lower number.

In some implementations, the sequence identifier stored by master device 210 may reference a data item identifier for data item 440 identified by the data item update received by master device 210. The data item identifier may identify data item 440. Additionally, or alternatively, the sequence identifier may reference an operation identifier for the operation identified by the data item update received by master device 210. The operation identifier may identify an operation (e.g., add, modify, or delete) to be performed on data item 440. Additionally, or alternatively, the sequence identifier may reference a memory location for the data item 440 identified by the data item update received by master device 210. The memory location may identify a location where data item 440 is stored in memory (e.g., on master device 210 and/or on another device). Additionally, or alternatively, the sequence identifier may reference a timestamp. The timestamp may indicate a time at which the data item update (e.g., data item 440, the sequence identifier, the data item identifier, the operation identifier, the memory location, and/or the timestamp) is received, processed, and/or stored by master device 210.

When storing a data item update in memory, master device 210 may use a sequence identifier to reference the data item update. In some implementations, master device 210 may determine a most recently used and/or stored sequence identifier, and may increment the most recently used/stored sequence identifier to generate a new sequence identifier to reference the data item update. For example, master device 210 may receive a data item update, may determine that the most recently used sequence identifier is three (3), and may assign a sequence identifier of four (4) to reference the received data item update.

Returning to FIG. 5, process 500 may include determining whether the operation is an add operation, a modify operation, or a delete operation (block 530). For example, master device 210 may determine whether the operation identified by the data item update is an add, modify, or delete operation.

As illustrated in FIG. 5, if the operation is an add operation (block 530—ADD), process 500 may include storing the data item in memory (block 540). An add operation may cause master device 210 to store, in memory, a data item update associated with a new data item 440 (e.g., not already stored by master device 210) and/or may store the new data item 440, and may not cause master device 210 to remove any other data item updates from memory.

As illustrated in FIG. 5, if the operation is a modify operation (block 530—MODIFY), process 500 may include removing information referenced by a previous sequence identifier that references the data item identifier (block 550), and modifying the data item (block 560). For example, a modify operation may cause master device 210 to store, in data item sequence table 450, a data item update associated with a modified data item 440 (e.g., a modification to a data item 440 already stored by master device 210), and may cause master device 210 to remove, from data item sequence table 450, a previous data item update associated with the data item 440 that has been modified. For example, master device 210 may determine a previous sequence identifier associated with data item 440, and may remove the information referenced by the previous sequence identifier (e.g., a data item identifier, an operation identifier, a memory location, and/or a timestamp). Master device 210 may also modify data item 440 according to the modification operation, and may store the modified data item 440 in memory.

As illustrated in FIG. 5, if the operation is a delete operation (block 530—DELETE), process 500 may include removing information referenced by a previous sequence identifier that references the data item identifier (block 570), and deleting the data item from memory (block 575). For example, a delete operation may cause master device 210 to store, in data item sequence table 450, information associated with a deleted data item 440 (e.g., a deletion of a data item 440 already stored by master device 210), and may cause master device 210 to remove, from data item sequence table 450, a previous data item update associated with the data item 440 that has been deleted. For example, master device 210 may determine a previous sequence identifier associated with data item 440, and may remove the information referenced by the previous sequence identifier (e.g., a data item identifier, an operation identifier, a memory location, and/or a timestamp). Master device 210 may also delete data item 440 from memory.

As further illustrated in FIG. 5, if the operation is a delete operation (block 530—DELETE), process 500 may further include receiving a deletion trigger (block 580), and removing information referenced by the sequence identifier, based on receiving the deletion trigger (block 585). For example, the delete operation may cause master device 210 to store, in data item sequence table 450, information associated with deleted data item 440 (e.g., a reference to a delete operation for data item 440). Upon receiving a deletion trigger, master device 210 may remove the information associated with deleted data item 440 (e.g., a data item identifier, an operation identifier, a memory location, and/or a timestamp) from data item sequence table 450. In some implementations, master device 210 may continue to store the sequence identifier in memory. In some implementations, the deletion trigger may be based on the timestamp. For example, master device 210 may trigger deletion of the information referenced by the next sequence identifier based on the timestamp satisfying a threshold (e.g., information older than a particular date/time may be deleted).

While a series of blocks has been described with regard to FIG. 5, the order of the blocks may be modified in some implementations. Additionally, or alternatively, non-dependent blocks may be performed in parallel.

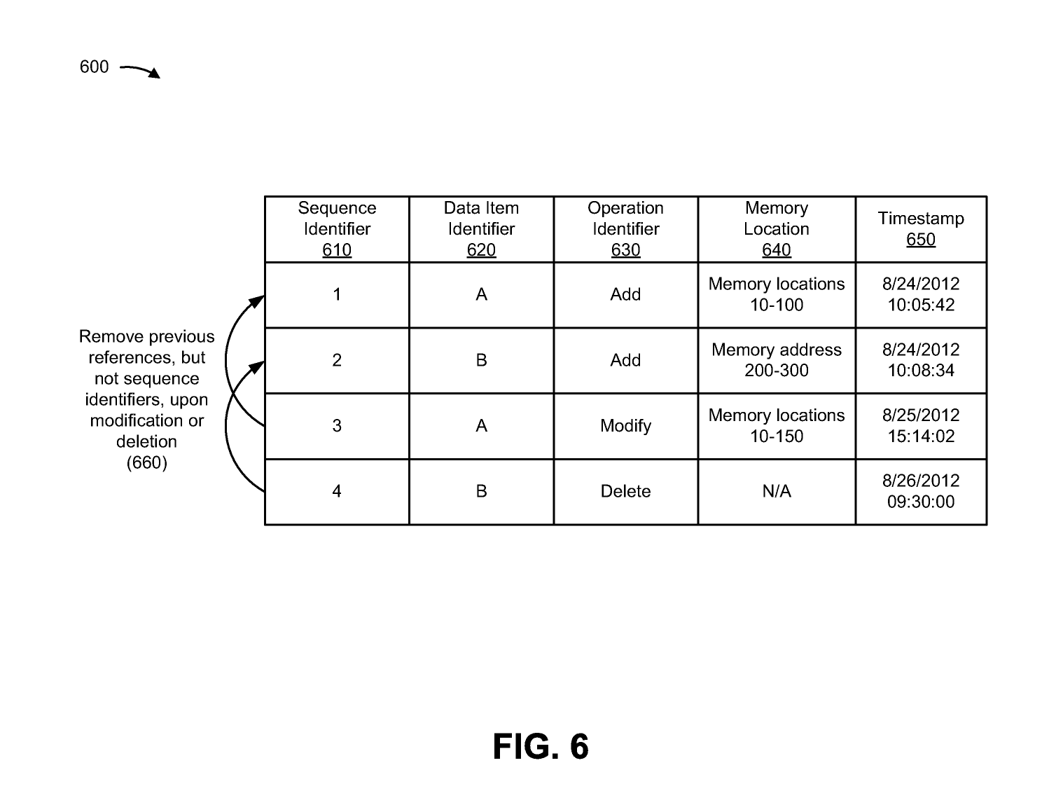

FIG. 6 is a diagram of an example data structure 600 that stores data item information. Data structure 600 may be stored in a memory device (e.g., a RAM, a hard disk, etc.), associated with one or more devices and/or components shown in FIGS. 2-4. For example, data structure 600 may be stored by master device 210 (e.g., in data item sequence table 450).

Data structure 600 may include a collection of fields, such as a sequence identifier field 610, a data item identifier field 620, an operation identifier field 630, a memory location field 640, and a timestamp field 650.

Sequence identifier field 610 may store information that identifies a sequence identifier. For example, the sequence identifier may be a number, a letter, a timestamp, or any other identifier capable of indicating an order in which information is received, processed, stored, etc.

Data item identifier field 620 may store information that identifies data item 440 referenced by the sequence identifier identified by sequence identifier field 610. For example, data item 440 may be identified by a number, a letter, a file name, a memory location, or any other identifier capable of identifying data item 440.

Operation identifier field 630 may store information that identifies an operation referenced by the sequence identifier identified by sequence identifier field 610. The operation may be an operation to be performed or that has already been performed on data item 440 identified by data item identifier field 620. For example, the operation may be an add operation, a modify operation, or a delete operation.

Memory location field 640 may store information that identifies a memory location referenced by the sequence identifier identified by sequence identifier field 610. The memory location may be a memory location where data item 440 identified by data item identifier field 620 is stored, or where a modified data item 440 (e.g., created by modifying the data item 440 identified by data item identifier field 620) is stored. For example, the memory location may specify a memory address, a memory block, a memory register, etc.

Timestamp field 650 may store information that identifies a date and/or a time referenced by the sequence identifier identified by sequence identifier field 610. In some implementations, the date/time may be a date/time when a data item update was received, processed, and/or stored by master device 210. For example, the date/time may be a date/time when the information stored in fields 610, 620, 630, 640, and/or 650 was received, processed, stored, etc. by master device 210.

Information associated with a single sequence identifier may be conceptually represented as a row in data structure 600. For example, the first row in data structure 600 may correspond to a sequence identifier of “1,” a data item identifier of “A,” an operation identifier of “add,” a memory location of “memory locations 10-100,” and a timestamp of “8/24/2012, 10:05:42.”

In some implementations, master device 210 may remove a reference to data item 440 when information that identifies an operation to modify and/or delete data item 440 is received, processed, stored, etc., as indicated by reference number 660. For example, the third row in data structure 600 is associated with a modification of data item A. Upon receiving, processing, and/or storing the information that identifies the operation, master device 210 may remove information in the first row of data structure 600 (which also corresponds to data item A), from data item sequence table 450. Likewise, upon receiving, processing, and/or storing information that identifies the delete operation associated with data item B in the fourth row of data structure 600, master device 210 may remove information in the second row of data structure 600 (which also corresponds to data item B), from data item sequence table 450. In some implementations, master device 210 may remove the information stored in fields 620-650, and may retain the information stored in field 610. Additionally, or alternatively, master device 210 may remove the information stored in fields 610-650 in any combination. In some implementations, master device 210 may remove information associated with data item 440 referenced by a previous sequence identifier so that only one sequence identifier (e.g., the most recently created/stored sequence identifier) references data item 440.

Data structure 600 includes fields 610-650 for explanatory purposes. In practice, data structure 600 may include additional fields, fewer fields, different fields, or differently arranged fields than those illustrated in FIG. 6. Additionally, the values illustrated in data structure 600 are provided for explanatory purposes. In some implementations, data structure 600 may include information provided by a user, an application, and/or a device. Although data structure 600 is represented as a table with rows and columns, in practice, data structure 600 may include any type of data structure, such as a linked list, a tree, a hash table, a database, or any other type of data structure.

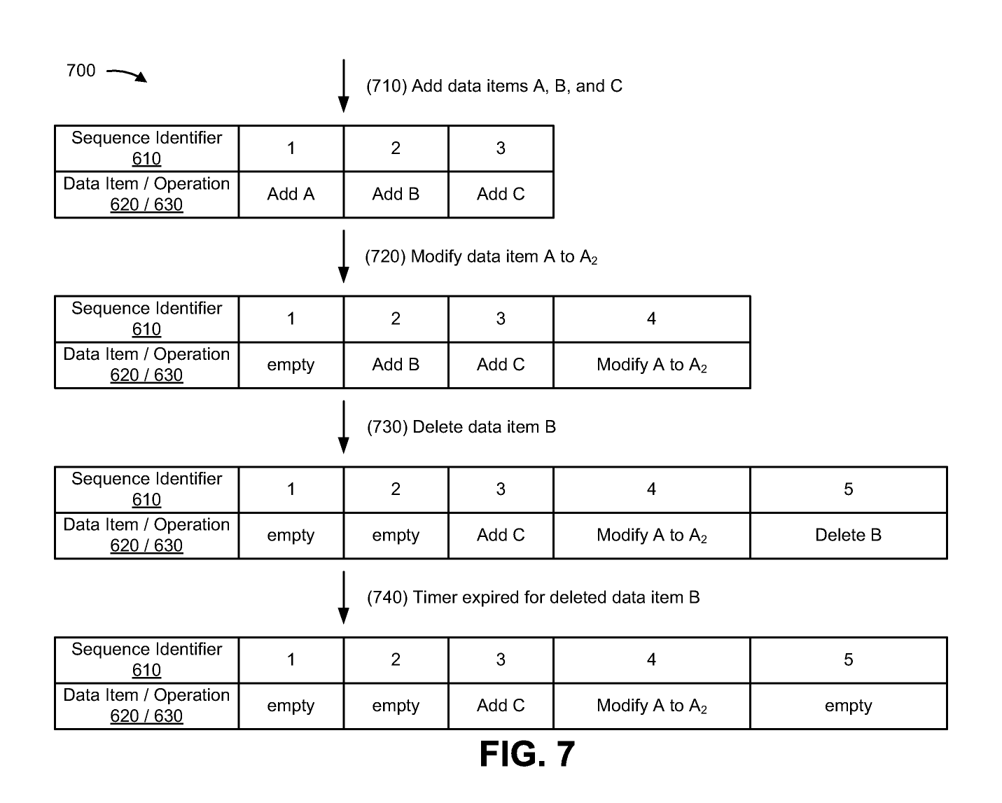

FIG. 7 is a diagram of an example implementation 700 relating to process 500, illustrated in FIG. 5. FIG. 7 illustrates an implementation 700 where master device 210 receives a data item update and updates data item sequence table 450 based on the received data item update.

As illustrated in FIG. 7, master device 210 may receive a date item update, and may store data item information associated with the data item update in data item sequence table 450, which may include sequence identifier field 610 (FIG. 6), data item identifier field 620 (FIG. 6), and operation identifier field 630 (FIG. 6).

Reference number 710 indicates that master device 210 may receive an indication to add data items A, B, and C to a memory of master device 210. In some implementations, master device 210 may store data items A, B, and C in memory based on the indication. Additionally, or alternatively, master device 210 may store a reference to data items A, B, and C, as well as a reference to the add operation, in data item sequence table 450. The “Add A” operation may be referenced by sequence identifier 1, the “Add B” operation may be referenced by sequence identifier 2, and the “Add C” operation may be referenced by sequence identifier 3, as illustrated.

Reference number 720 indicates that master device 210 may receive an indication to modify data item A to produced modified data item A₂ (e.g., replace A with A₂). In some implementations, master device 210 may modify data item A in memory, to produce modified data item A₂ (e.g., may store modified data item A₂ in memory, and may remove data item A from memory) based on the indication. Additionally, or alternatively, master device 210 may store a reference to modified data item A₂ in data item sequence table 450. The “Modify A to A₂” operation may be referenced by sequence identifier 4 (e.g., the next sequence identifier), as illustrated. Master device 210 may also remove the previous reference to data item A, referenced by sequence identifier 1, from data item sequence table 450. After the removal, sequence identifier 1 may be associated with an empty (e.g., null) entry in data item sequence table 450.

Reference number 730 indicates that master device 210 may receive an indication to delete data item B from a memory of master device 210. In some implementations, master device 210 may delete data item B from memory based on the indication. Additionally, or alternatively, master device 210 may store a reference to deleted data item B in data item sequence table 450. The “Delete B” operation may be referenced by sequence identifier 5 (e.g., the next sequence identifier), as illustrated. Master device 210 may also remove the previous reference to data item B, referenced by sequence identifier 2, from data item sequence table 450.

Reference number 740 indicates that master device 210 may determine that a deletion trigger timer has expired for deleted data item B. The deletion trigger may be based on a timestamp associated with sequence identifier 5 satisfying a threshold. Upon receiving the deletion trigger, master device 210 may remove the reference to the deletion of data item B (e.g., “Delete B”), referenced by sequence identifier 5, from data item sequence table 450.

The information received and stored by master device 210, as indicated by reference numbers 710-740 and fields 610-630, is provided for explanatory purposes. In practice, master device 210 may receive and/or store additional information, less information, different information, and/or differently arranged information than illustrated in FIG. 7.

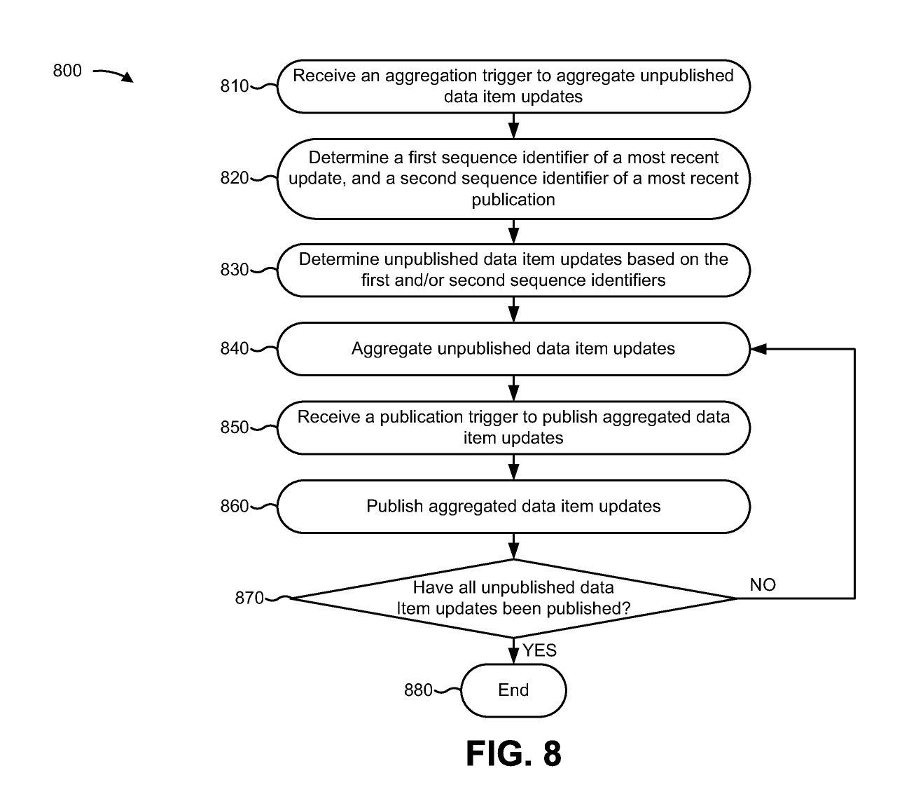

FIG. 8 is a diagram of an example process 800 for aggregating and publishing data item updates. In some implementations, one or more process blocks of FIG. 8 may be performed by one or more components of master device 210. Additionally, or alternatively, one or more process blocks of FIG. 8 may be performed by one or more components of another device or a collection of devices including or excluding master device 210.

As illustrated in FIG. 8, process 800 may include receiving an aggregation trigger to aggregate unpublished data item updates (block 810). In some implementations, the aggregation trigger may be received based on a quantity of unpublished data item updates satisfying a threshold. As used herein, “publishing” a data item update may refer to sending, from master device 210, data item 440 and/or information associated with data item 440 (e.g., data item information, such as a sequence identifier, a data item identifier, an operation identifier, etc.) to slave device 220. An “unpublished” data item update may refer to a data item update (e.g., a data item 440 and/or data item information associated with data item 440) that has not been sent by master device 210 to slave device 220. In some implementations, master device 210 may store a quantity of unpublished data item updates, and may trigger aggregation of unpublished data item updates when the quantity of unpublished data item updates satisfies a threshold.

In some implementations, master device 210 may trigger aggregation of unpublished data item updates based on an aggregation timer satisfying a threshold. For example, master device 210 may determine an amount of time that has passed since a previous aggregation was triggered, since a previous publication was sent, etc., and may trigger aggregation based on the amount of time satisfying a threshold.

As further illustrated in FIG. 8, process 800 may include determining a first sequence identifier of a most recent update, determining a second sequence identifier of a most recent publication (block 820), and determining unpublished data item updates based on the first and/or second sequence identifiers (block 830). In some implementations, the most recent update may refer to a data item update most recently received, processed, stored, etc. by master device 210. In some implementations, master device 210 may determine the first sequence identifier of the most recent update based on a most recent sequence identifier (e.g., the highest sequence number).

The most recent publication may refer to a data item update most recently published (e.g., pushed) by master device 210. In some implementations, master device 210 may determine the second sequence identifier of the most recent publication by storing the most recent sequence identifier (e.g., the highest sequence number) of the most recent publication.

In some implementations, master device 210 may determine the unpublished data item updates as the data item updates referenced by a sequence identifier more recent than the sequence identifier of the most recent publication. Additionally, or alternatively, master device 210 may determine the unpublished data item updates as the data item updates referenced by a sequence identifier falling between the first sequence identifier and the second sequence identifier (including the first sequence identifier).

As further illustrated in FIG. 8, process 800 may include aggregating unpublished data item updates (block 840), receiving a publication trigger to publish the aggregated data item updates (block 850), and publishing the aggregated data item updates (block 860). In some implementations, master device 210 may aggregate unpublished data item updates by storing the unpublished data item updates in a buffer (e.g., a memory of a particular size), and may publish the aggregated data item updates by sending the data item updates stored in the buffer to slave device 220. In some implementations, master device 210 may maximize the quantity of unpublished data item updates stored in the buffer.

Master device 210 may publish the aggregated data item updates based on receiving a publication trigger. In some implementations, the publication trigger may be based on a publication timer satisfying a threshold. For example, master device 210 may determine an amount of time that has passed since a previous publication was triggered, since a previous publication was sent, since an aggregation was triggered, etc., and may trigger publication based on the amount of time satisfying a threshold. Additionally, or alternatively, the publication trigger may be based on a quantity of slave devices 220, capable of receiving the publication, satisfying a threshold. For example, master device 210 may determine that a quantity of slave devices 220, that are powered on and/or able to communicate with master device 210, satisfies a threshold, and may trigger publication based on the determination.

As further illustrated in FIG. 8, process 800 may include determining whether all unpublished data item updates have been published (block 870). For example, master device 210 may not have published all of the unpublished data item updates when all of the unpublished data item updates could not be stored in the buffer. In some implementations, master device 210 may determine whether there are any remaining unpublished data item updates.

As further illustrated in FIG. 8, if all unpublished data item updates have been published (block 870—YES), process 800 may end (block 880). However, if all unpublished data item updates have not been published (block 870—NO), process 800 may return to block 840, and may include aggregating the remaining unpublished data item updates.

While a series of blocks has been described with regard to FIG. 8, the order of the blocks may be modified in some implementations. Additionally, or alternatively, non-dependent blocks may be performed in parallel.

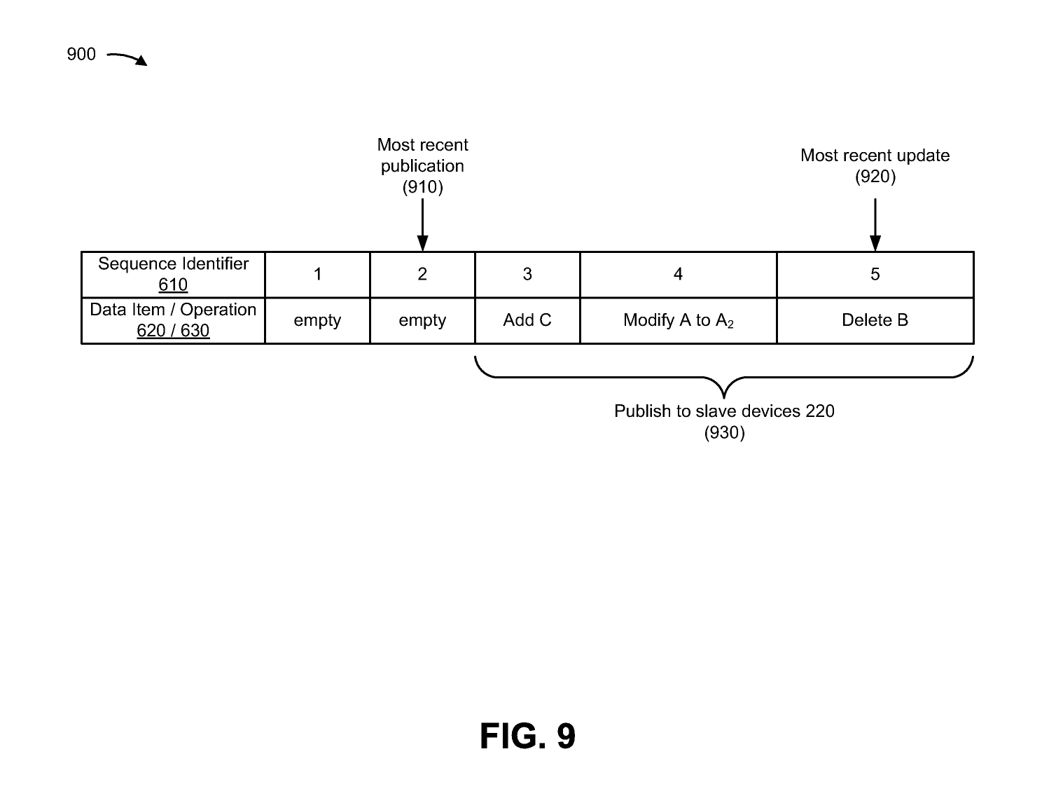

FIG. 9 is a diagram of an example implementation 900 relating to process 800, illustrated in FIG. 8. FIG. 9 illustrates an implementation 900 where master device 210 determines which data item updates to publish, from data item sequence table 450, based on a most recent publication (indicated by reference number 910) and a most recent update (indicated by reference number 920).

As illustrated in FIG. 9, master device 210 may store information in data item sequence table 450, which may include sequence identifier field 610 (FIG. 6), data item identifier field 620 (FIG. 6), and operation identifier field 630 (FIG. 6). In some implementations, master device 210 may publish, to slave devices 220, information stored in data item sequence table 450.

Reference number 910 indicates a most recent publication (e.g., a most recently published data item update), associated with sequence identifier 2. For example, reference number 910 may indicate that during the most recent publication (e.g., a push publication) to slave devices 220, master device 210 published data item 440 and/or data item information associated with data item 440, referenced by sequence identifier 2.

Reference number 920 indicates a most recent update (e.g., a most recently received, processed, and/or stored data item update), associated with sequence identifier 5. For example, reference number 920 may indicate that data item 440 and/or data item information associated with data item 440, referenced by sequence identifier 5, was received, processed, and/or stored most recently (e.g., when compared to another data item update received, processed, and/or stored) by master device 210.

Reference number 930 indicates that data item updates referenced by sequence identifiers 3, 4, and 5, are to be published, by master device 210, to slave devices 220. In some implementations, master device 210 may determine to publish data item updates associated with sequence identifiers 3, 4, and 5 because these sequence identifiers are more recent than the most recent publication 910 (e.g., referenced by sequence identifier 2). Additionally, or alternatively, master device 210 may determine to publish data item updates associated with sequence identifiers 3, 4, and 5 because these sequence identifiers fall in between the most recent publication 910 (e.g., referenced by sequence identifier 2) and the most recent update 920 (e.g., referenced by sequence identifier 5), including sequence identifier 5, but not including sequence identifier 2.

When publishing data items to slave devices 220, master device 210 may transmit different information based on the operation identified by the data item update being published. For example, sequence identifier 3 is associated with an add operation (“Add C”). When publishing a data item update that includes an add operation, master device 210 may transmit the data item 440 associated with the add operation (e.g., data item C), a data item identifier that identifies data item 440 (e.g., an identifier for data item C), and/or an operation identifier that identifies the operation to be performed on data item 440 (e.g., add data item C).

As another example, sequence identifier 4 is associated with a modify operation (“Modify A to A₂”). When publishing a data item update that includes a modify operation, master device 210 may transmit the data item 440 associated with the modify operation (e.g., data item A₂), a data item identifier that identifies a data item 440 to be modified (e.g., an identifier for data item A), and/or an operation identifier that identifies the operation to be performed on the data item 440 to be modified (e.g., modify data item A to data item A₂).

As another example, sequence identifier 5 is associated with a delete operation (“Delete B”). When publishing a data item update that includes a delete operation, master device 210 may transmit a data item identifier that identifies a data item 440 to be deleted (e.g., an identifier for data item B), and/or an operation identifier that identifies the operation to be performed on the data item 440 (e.g., delete data item B). For delete operations, master device 210 may not transmit the data item 440 associated with the delete operation because the data item 440 associated with the delete operation has been deleted by master device 210.

The information updated and published by master device 210, as indicated by reference numbers 910-930 and fields 610-630, is provided for explanatory purposes. In practice, master device 210 may update and/or publish additional information, less information, different information, and/or differently arranged information than illustrated in FIG. 9.

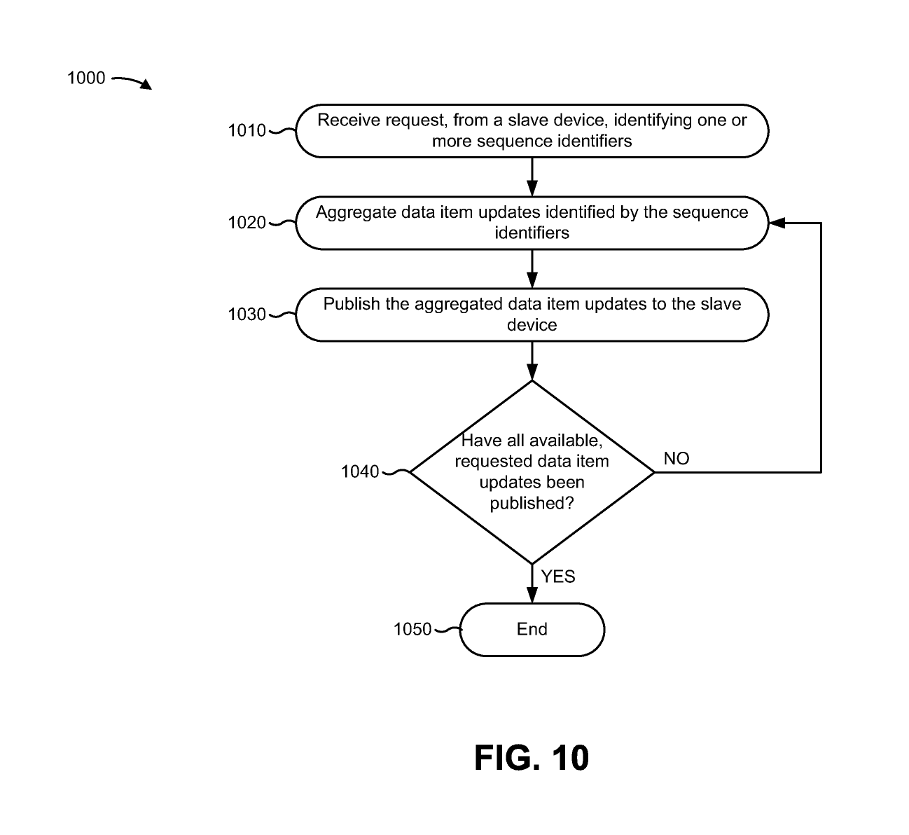

FIG. 10 is a diagram of an example process 1000 for responding to requests from slave devices. In some implementations, one or more process blocks of FIG. 10 may be performed by one or more components of master device 210. Additionally, or alternatively, one or more process blocks of FIG. 10 may be performed by one or more components of another device or a collection of devices including or excluding master device 210.

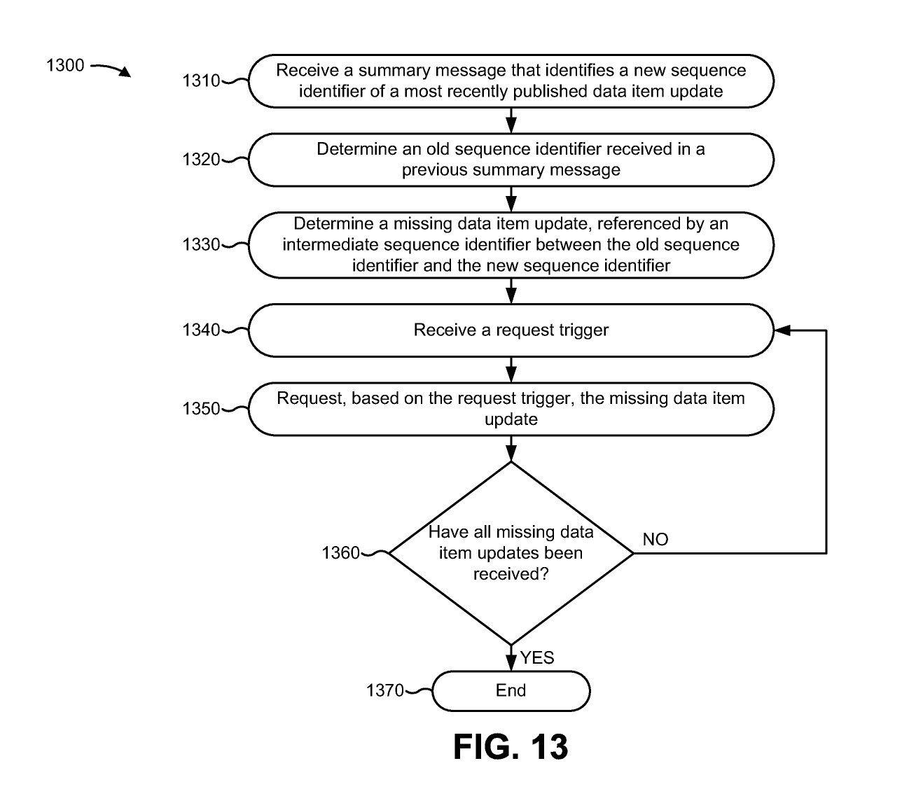

As illustrated in FIG. 10, process 1000 may include receiving a request, from a slave device, identifying one or more sequence identifiers (block 1010). In some implementations, slave device 220 may determine a sequence identifier associated with a missing data item update (e.g., a data item update that is not stored by slave device 220), and may transmit the sequence identifier to master device 210, as discussed in further detail in connection with FIG. 13.

As further illustrated in FIG. 10, process 1000 may include aggregating data item updates identified by the sequence identifiers (block 1020), and publishing the aggregated data item updates to the slave device (block 1030). In some implementations, master device 210 may aggregate the requested data item updates by storing the requested data item updates in a buffer (e.g., a memory of a particular size), and may publish the aggregated data item updates by sending the requested data item updates, stored in the buffer, to slave device 220. In some implementations, master device 210 may maximize the quantity of requested data item updates stored in the buffer. Additionally, or alternatively, master device 210 may publish the aggregated data item updates based on receiving a publication trigger, as discussed herein in connection with FIG. 8.

As further illustrated in FIG. 10, process 1000 may include determining whether all available, requested data item updates have been published (block 1040). For example, master device 210 may not have published all of the requested data item updates when all of the requested data item updates could not be stored in the buffer. In some implementations, master device 210 may determine the remaining requested data item updates. Additionally, or alternatively, a data item update may be unavailable if a sequence number associated with the data item update references an empty entry in data item sequence table 450. In some implementations, master device 210 may not send the empty entry. In some implementations, master device 210 may determine the remaining available, requested data item updates.

As further illustrated in FIG. 10, if all available, requested data item updates have been published (block 1040—YES), process 1000 may end (block 1050). However, if all available, requested data item updates have not been published (block 1040—NO), process 1000 may return to block 1020, and may include aggregating the remaining available, requested data item updates.

While a series of blocks has been described with regard to FIG. 10, the order of the blocks may be modified in some implementations. Additionally, or alternatively, non-dependent blocks may be performed in parallel.

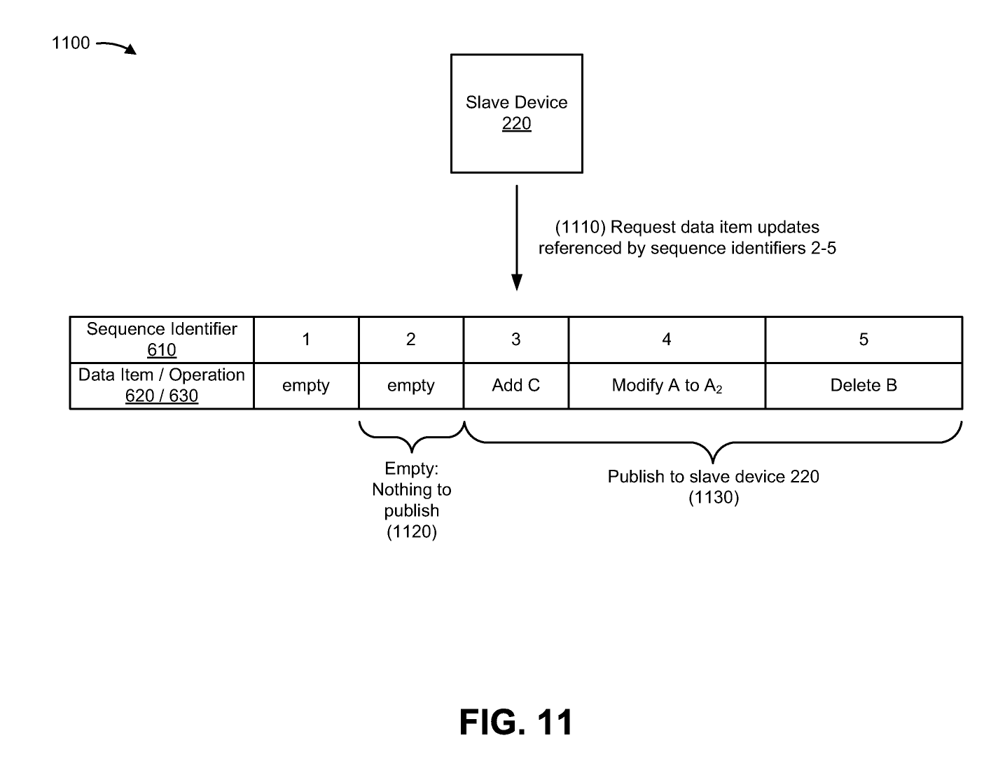

FIG. 11 is a diagram of an example implementation 1100 relating to process 1000, illustrated in FIG. 10. FIG. 11 illustrates an implementation 1100 where master device 210 receives a request, from slave device 220, for a data item update referenced by one or more sequence identifiers, and publishes the available, requested data item updates.

As illustrated in FIG. 11, master device 210 may store information in data item sequence table 450, which may include sequence identifier field 610 (FIG. 6), data item identifier field 620 (FIG. 6), and operation identifier field 630 (FIG. 6). In some implementations, master device 210 may publish, to slave device 220, a data item update (e.g., a data item 440 and/or data item information associated with data item 440), based on a request from slave device 220.

Reference number 1110 indicates a request, received from slave device 220, for a data item update referenced by sequence identifiers 2-5 (e.g., 2, 3, 4, and 5). Slave device 220 may transmit the request to master device 210.

Reference number 1120 indicates a data item update that will not be published to slave device 220 because sequence identifier 2 is associated with an empty (e.g., null) entry. In other words, master device 210 has removed the information associated with sequence identifier 2 (e.g., discussed in connection with reference number 730, FIG. 7), and there is no information associated with sequence identifier 2 to transmit to slave device 220.

Reference number 1130 indicates that a data item update referenced by sequence identifiers 3, 4, and 5, are to be published, by master device 210, to slave device 220. In some implementations, master device 210 may determine to publish information associated with sequence identifiers 3, 4, and 5 because these sequence identifiers are associated with available, requested data item updates. When publishing data item updates to slave devices 220, master device 210 may send different information based on the operation associated with the data item update, as discussed herein in connection with FIG. 9.

The information received and published by master device 210, as indicated by reference numbers 1110-1130 and fields 610-630, is provided for explanatory purposes. In practice, master device 210 may receive and/or publish additional information, less information, different information, and/or differently arranged information than illustrated in FIG. 11.

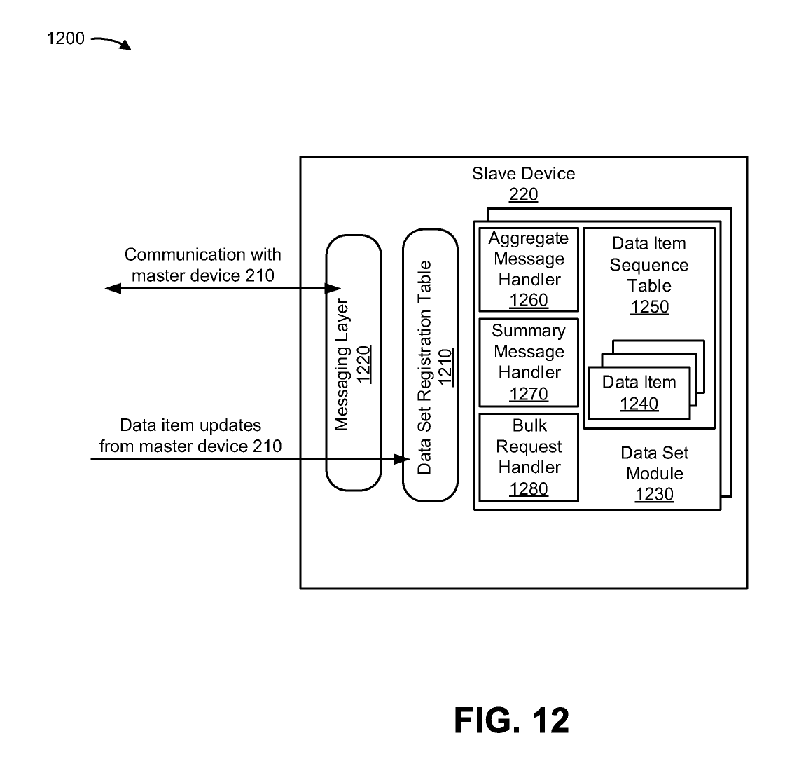

FIG. 12 is a diagram of example functional components of a device 1200 that may correspond to slave device 220. In another implementation, one or more of the example functional components of device 1200 may be implemented by another device or a collection of devices including or excluding slave device 220. As illustrated, device 1200 may include a data set registration table 1210, a messaging layer 1220, and a data set module 1230. Data set module 1230 may include a data item sequence table 1250, an aggregate message handler 1260, a summary message handler 1270, and a bulk request handler 1280. Data item sequence table 1250 may include one or more data items 1240.

Data set registration table 1210 may perform operations associated with creating and managing data sets. In some implementations, data set registration table 1210 register a data set, unregister a data set, update a data set, enable access to a data set, and/or disable access to a data set in the same manner as data set registration table 410 (FIG. 4). For example, data set registration table 1210 may receive a registration request for a data set to be replicated on slave device 220, and may register the data set based on the registration request. In some implementations, data set registration table 1210 may receive data item updates from master device 210 to update a data set.

Messaging layer 1220 may perform operations associated with communicating with master device 210. For example, messaging layer 1220 may enable slave device 220 to be aware of master device 210, and to communicate with master device 210. In some implementations, messaging layer 1220 may receive a data item update from master device 210 via multicasting. For example, slave device 220 may subscribe to a multicast update for a particular data set (e.g., a data set stored and/or to be stored by slave device 220). Master device 210 may transmit updates to the particular data set to slave devices 220 that are subscribed to the multicast update for the particular data set. Additionally, or alternatively, messaging layer 1220 may transmit a pull request to master device 210, and may receive a data item update from master device 210 in response to the pull request.

Data set module 1230 may perform operations associated with maintaining data sets. In some implementations, data set module 1230 may store data items 1240. Data items 1240 stored by slave device 220 may correspond to data items 440 stored by master device 210. In some implementations, data set module 1230 may store data item information in data item sequence table 1250. In some implementations, data set module 1230 may manage receiving data item updates via aggregate message handler 1260, summary message handler 1270 (which may detect missing data item updates), and/or bulk request handler 1280, as explained in further detail in connection with FIGS. 13-16B. In some implementations, slave device 220 may include multiple data set modules 1230, one for each data set stored by slave device 220 (which may be a subset of the data sets stored by master device 210).

Data item sequence table 1250 may store data item information. The information stored by data item sequence table 1250 on slave device 220 may correspond to the information stored by data item sequence table 450 on master device 210.

Aggregate message handler 1260 may perform operations associated with receiving data item updates from master device 210. In some implementations, aggregate message handler 1260 may receive data item updates pushed from master device 210.

Summary message handler 1270 may perform operations associated with receiving notifications, from master device 210, associated with data item updates. For example, summary handler 1270 may periodically receive a summary message from master device 210 that contains an indication of the most recent publication (e.g., a most recently published data item update). Slave device 220 may use the indication to determine whether slave device 220 is synchronized with master device 210 (e.g., whether the data sets shared by master device 210 and slave device 220 are identical).

Bulk request handler 1280 may perform operations associated with requesting and/or receiving missing data item updates from master device 210. For example, bulk request handler 1280 may transmit a pull request, to master device 210, that identifies a data item update that is missing from a memory of slave device 220. Bulk request handler 1280 may receive the missing data item update from master device 210.

The number of functional components illustrated in FIG. 12 is provided for explanatory purposes. In practice, there may be additional functional components, fewer functional components, different functional components, or differently arranged functional components than those illustrated in FIG. 12. Functional components 1210-1280 may be implemented using one or more devices 300 or one or more components of device 300. Slave device 220 may individually include all of the functional components depicted in FIG. 12, or the functional components depicted in FIG. 12 may be distributed singularly or duplicatively in any manner between the devices illustrated in FIG. 2.

FIG. 13 is a diagram of an example process 1300 for requesting missing data item information. In some implementations, one or more process blocks of FIG. 13 may be performed by one or more components of slave device 220. Additionally, or alternatively, one or more process blocks of FIG. 13 may be performed by one or more components of another device or a collection of devices including or excluding slave device 220.

As illustrated in FIG. 13, process 1300 may include receiving a summary message that identifies a new sequence identifier of a most recently published data item update (block 1310), and determining an old sequence identifier received in a previous summary message (block 1320). In some implementations, master device 210 may periodically transmit a summary message to slave device 220, and slave device 220 may receive the summary message. The summary message may include a sequence identifier that identifies a data item update most recently published by master device 210. Slave device 220 may compare a new sequence identifier, included in a most recently received summary message, to an old sequence identifier, included in a summary message previously received by slave device 220 (e.g., received by slave device 220 before the most recently received summary message). In some implementations, the previously received summary message may be a second most recently received summary message (e.g., a summary message received prior to the most recently received summary message, without any intervening received summary messages).

As further illustrated in FIG. 13, process 1300 may include determining a missing data item update, referenced by an intermediate sequence identifier between the old sequence identifier and the new sequence identifier (block 1330), receiving a request trigger (block 1340), and requesting, based on the request trigger, the missing data item update (block 1350). In some implementations, slave device 220 may store received sequence identifiers (e.g., in data item sequence table 1240). In some implementations, slave device 220 may determine an intermediate sequence identifier, more recent than the old sequence identifier and less recent than or equally as recent as the new sequence identifier, that is not stored by slave device 220. Slave device 220 may transmit a request, to master device 210, for a data item update referenced by the determined intermediate sequence identifier.

In some implementations, slave device 220 may automatically create and store a missing sequence identifier that falls between received sequence identifiers. Slave device 220 may store an empty entry, referenced by the missing sequence identifier. In some implementations, slave device 220 may request, from master device 210, a data item update for a sequence identifier associated with an empty entry on slave device 220. In this implementation, slave device 220 may store impacted sequence identifiers that are associated with an empty entry as a result of information being removed due to a modify or delete operation. Slave device 220 may not use the impacted sequence identifiers when requesting missing data item updates from master device 210. Additionally, or alternatively, slave device 220 may delete the stored impacted sequence identifiers more recent than the old sequence identifier and less recent than or equally as recent as the new sequence identifier, after processing the most recently received summary message (e.g., in process block 1370).

In some implementations, slave device 220 may request the missing data item update based on receiving a request trigger. In some implementations, the request trigger may be based on a request timer satisfying a threshold. For example, slave device 220 may determine an amount of time that has passed since a previous request was triggered, since a previous request was sent by slave device 220 to master device 210, etc., and may trigger sending of the request based on the amount of time satisfying a threshold. Additionally, or alternatively, the request trigger may be based on a determination that master device 210 is capable of responding to the request. For example, slave device 210 may determine that master device 210 is powered on and/or able to communicate with slave device 220, and may trigger the request based on the determination.

Returning to FIG. 13, process 1300 may include determining whether all missing data item updates have been received (block 1360). In some implementations, slave device 220 may wait for a response to the request, from master device 210, and may determine whether all requested data item updates have been received in the response. Additionally, or alternatively, slave device 220 may wait for an amount of time to pass (e.g., satisfying a threshold), and may determine whether all requested data item updates have been received after the amount of time has passed. In some implementations, slave device 220 may determine the remaining missing data updates that have not been received.

In some implementations, slave device 220 may determine whether all requested data item updates have been received by using a request list that keeps track of missing data item updates. Slave device 220 may store the request list, and the request list may store a list of missing data item updates. Slave device 220 may send requests to master device 210 for missing data item updates identified by the request list. When slave device 220 receives a missing data item update, that missing data item update may be removed from the request list. An empty request list indicates that slave device 220 has received all missing data item updates. A non-empty request list indicates that slave device 220 has not received all missing data item updates. In some implementations, slave device 220 may request multiple data items 440 (e.g., identified by sequence identifiers), and may periodically send requests for data items 440 that have not been received. As data items 440 are received by slave device 220, the request list may be updated to remove the received data item updates.

As further illustrated in FIG. 13, if all missing data item updates have been received (block 1360—YES), process 1300 may end (block 1370). However, if all missing data item updates have not been received (block 1360—NO), process 1300 may return to block 1340, and may include receiving a request trigger, and requesting the remaining missing data updates, from master device 210, based on the request trigger.

While a series of blocks has been described with regard to FIG. 13, the order of the blocks may be modified in some implementations. Additionally, or alternatively, non-dependent blocks may be performed in parallel.

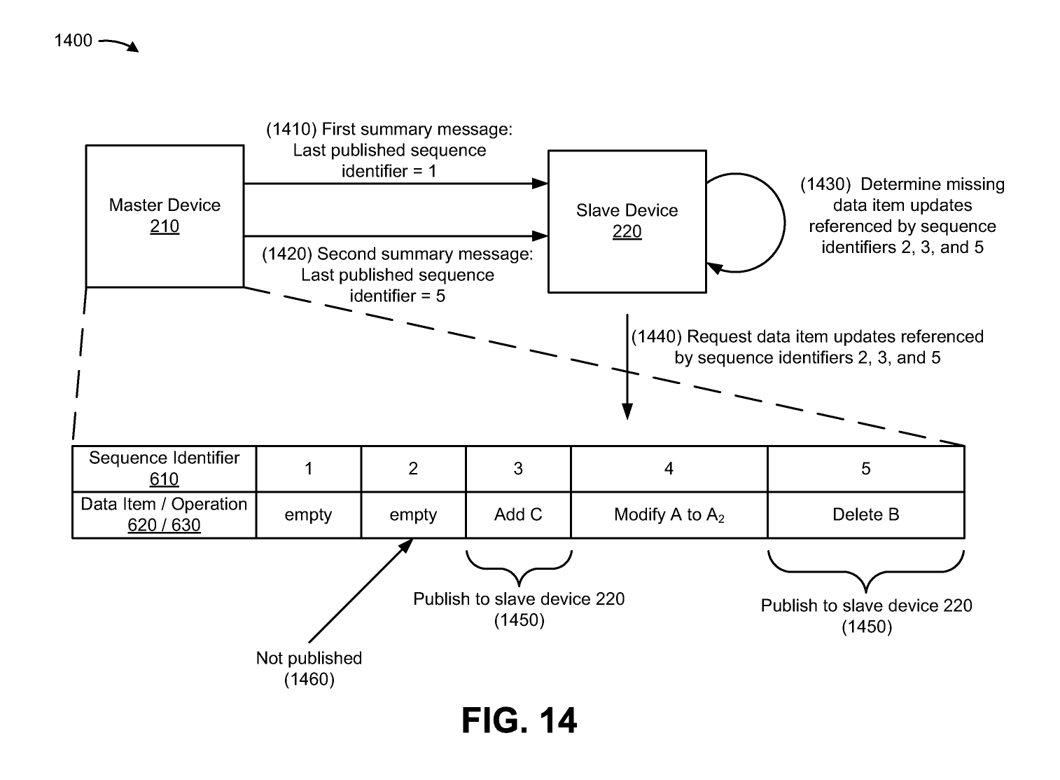

FIG. 14 is a diagram of an example implementation 1400 relating to process 1300, illustrated in FIG. 13. FIG. 14 illustrates an implementation 1400 where slave device receives summary messages from master device 210, determines missing data item updates, and requests the missing data item updates from master device 210.

As illustrated in FIG. 14, master device 210 may store information in data item sequence table 450, which may include sequence identifier field 610 (FIG. 6), data item identifier field 620 (FIG. 6), and operation identifier field 630 (FIG. 6). In some implementations, master device 210 may publish, to slave device 220, a data item update (e.g., a data item 440 and/or data item information associated with data item 440), based on a request from slave device 220.

Reference number 1410 indicates a first summary message sent from master device 210 to slave device 220. The first summary message indicates that a most recently published data item update is referenced by sequence identifier 1. The first summary message may be sent by master device 210 to slave device 220 at a first time T=1.

Reference number 1420 indicates a second summary message sent from master device 210 to slave device 220. The second summary message indicates that a most recently published data item update is referenced by sequence identifier 5. The second summary message may be sent by master device 210 to slave device 220 at a second time T>1.

Reference number 1430 indicates that slave device 220 may determine that slave device 220 is missing data item updates associated with sequence identifiers 2, 3, and 5. For example, slave device 220 may check a request list, stored by slave device 220, that identifies sequence identifiers 2, 3, and 5 as missing data item updates.

Reference number 1440 indicates a request, from slave device 220 to master device 210, for data item updates referenced by sequence identifiers 2, 3, and 5. Reference number 1450 indicates that the data item updates, referenced by sequence identifiers 3 and 5, are to be published by master device 210 to slave device 220. Reference number 1460 indicates that the data item update reference by sequence identifier 2 is not published by master device 210 to slave device 220 because it has been previously modified or deleted by master device 210 (e.g., sequence identifier 2 references an empty entry). When publishing data item updates to slave devices 220, master device 210 may send different information based on the operation associated with the data item update, as discussed herein in connection with FIG. 9.

The information sent in a summary message and/or published by master device 210, as well as the information determined and/or requested by slave device 220, as indicated by reference numbers 1410-1450 and fields 610-630, is provided for explanatory purposes. In practice, master device 210 and/or slave device 220 may be associated with additional information, less information, different information, and/or differently arranged information than illustrated in FIG. 14.

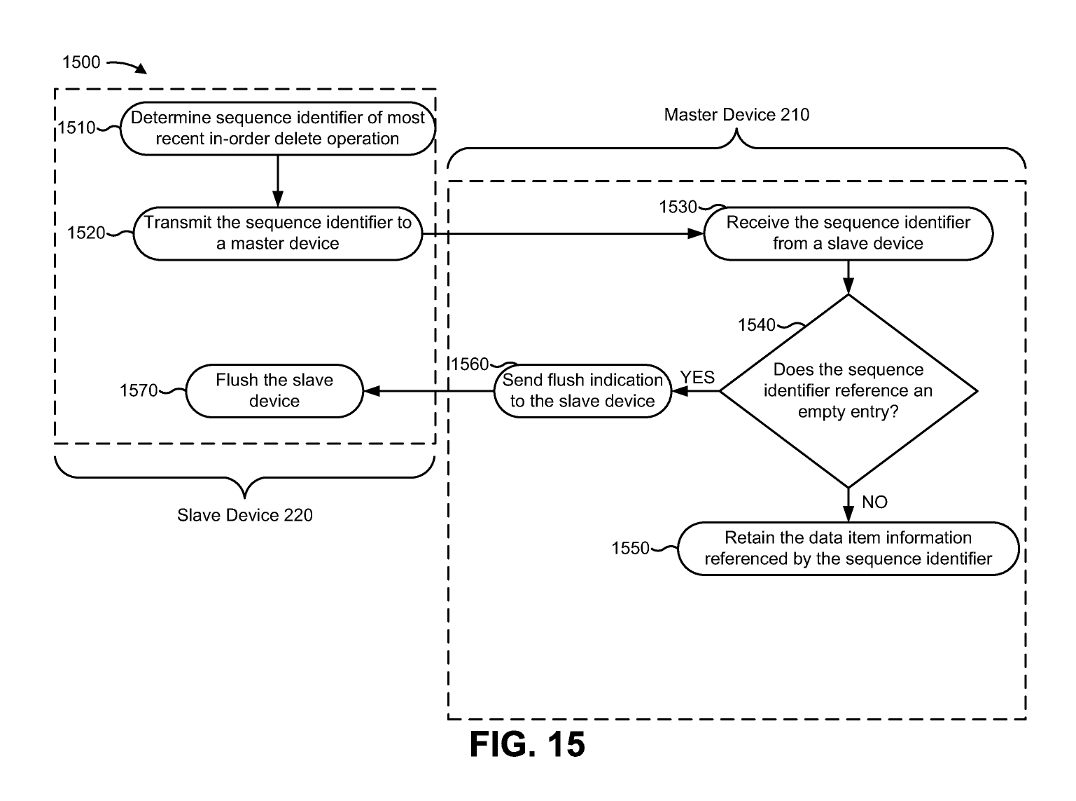

FIG. 15 is a diagram of an example process 1500 for handling stale data item updates. In some implementations, one or more process blocks of FIG. 15 may be performed by one or more components of master device 210 and/or slave device 220. For example, process blocks 1510, 1520, and 1580 may be performed by slave device 220, and process blocks 1530-1570 may be performed by master device 210. Additionally, or alternatively, one or more process blocks of FIG. 15 may be performed by one or more components of another device or a collection of devices including or excluding master device 210 and/or slave device 220.

As illustrated in FIG. 15, process 1500 may include determining a sequence identifier of a most recent in-order delete operation (block 1510), and transmitting the sequence identifier to a master device (block 1520). In some implementations, slave device 210 may determine, based on information stored in data item sequence table 1250, an in-order delete operation referenced by a most recent sequence identifier (e.g., a delete operation with the highest sequence number, when compared to other delete operations). In some implementations, slave device 210 may determine the sequence identifier of the most recent delete operation when slave device 220 is synchronized with master device 210 (e.g., when a data set is identical on both master device 210 and slave device 220). In this way, slave device 220 is guaranteed to determine the sequence identifier of the most recent delete operation because there will not be any missing data item updates (and therefore, no missing delete operations) on slave device 220.

Additionally, or alternatively, slave device 220 may determine the sequence identifier of the most recent delete operation based on a delete operation received in a response, by master device 210, to a pull request, from slave device 220. For example, slave device 220 may determine the sequence identifier of the most recent delete operation after a response to the pull request is complete (e.g., once slave device 220 is synchronized). Slave device 220 may store the sequence identifier, and may transmit the sequence identifier to master device 210.

As further illustrated in FIG. 15, process 1500 may include receiving the sequence identifier from a slave device (block 1530), and determining whether the sequence identifier references an empty entry (block 1540). In some implementations, master device 210 may receive the sequence identifier from slave device 220, and may determine whether the sequence identifier references, in data item sequence table 450 on master device 210, an empty entry (e.g., information previously deleted due to a deletion trigger timer expiration).

As further illustrated in FIG. 15, if the sequence identifier does not reference an empty entry (block 1540—NO), process 1500 may include retaining the data item information referenced by the sequence identifier (block 1550). In some implementations, master device 210 may determine that the sequence identifier, received from slave device 220, does not reference an empty entry in data item sequence table 450. Based on the determination, master device 210 may retain the information referenced by the sequence identifier.

In some implementations, master device 210 may remove data item information for delete operations upon the expiration of a timer. For example, upon determining that the sequence identifier does not reference an empty entry, master device 210 may start a timer. When the timer expires, master device 210 may remove the data item information. Additionally, or alternatively, master device 210 may remove data item information referenced by the old sequence identifier when the old sequence identifier is older than a sequence identifier received from multiple slave devices 220 (e.g., all slave devices 220, or a quantity of slave devices 220 that satisfies a threshold).

As further illustrated in FIG. 15, if the sequence identifier references an empty entry (block 1540—YES), process 1500 may include sending a flush indication to the slave device (block 1560), and flushing the slave device (block 1570). For example, master device 210 may determine that the sequence identifier references an empty entry, which may indicate that master device 210 is not capable of synchronizing with slave device 220. For example, slave device 220 may have missed a data item update that includes a delete operation, and may continue to store a data item 440/1240 which should have been deleted based on the delete operation. As a result, master device 210 may transmit a flush indication to slave device 220. Slave device 220 may receive the flush indication, and may flush slave device 220 based on the flush indication. Flushing slave device 220 may include deleting data items 440/1240 from slave device 220, and deleting data item information stored in data item sequence table 1250.

In some implementations, master device 210 may send a fake delete operation to slave device 220, which is treated as a delete operation by slave device 220. In other words, the sequence identifier that references the fake delete operation may be treated by slave device 220 as the sequence identifier of the most recent delete operation.

In this way, master device 210 may avoid sending a flush indication to slave device 220 when a deletion trigger timer has expired for a delete operation stored by master device 210. For example, master device 210 may send, to slave device 220, a first sequence identifier that references a delete operation for data item 440. Slave device 220 may include the first sequence identifier in a request for a missing data item update. If master device 210 does not send any other delete operations, and a deletion trigger timer expires for the first sequence identifier on master device 210, then the first sequence identifier may be associated with an empty entry, which may cause master device 210 to send a flush indication to slave device 220.

In order to avoid this unnecessary flush, master device 210 may send, to slave device 220, a second sequence identifier that references a fake delete operation. Slave device 220 may include the second sequence identifier in a request for a missing data item update. Thus, when the deletion trigger timer expires for the first sequence identifier on master device 210, it will not cause a flush indication to be sent when the second sequence identifier is received in a request from slave device 220. In some implementations, master device 210 may limit the quantity of fake delete operations sent to slave device 220 per deletion trigger timer expiration period.

While a series of blocks has been described with regard to FIG. 15, the order of the blocks may be modified in some implementations. Additionally, or alternatively, non-dependent blocks may be performed in parallel.

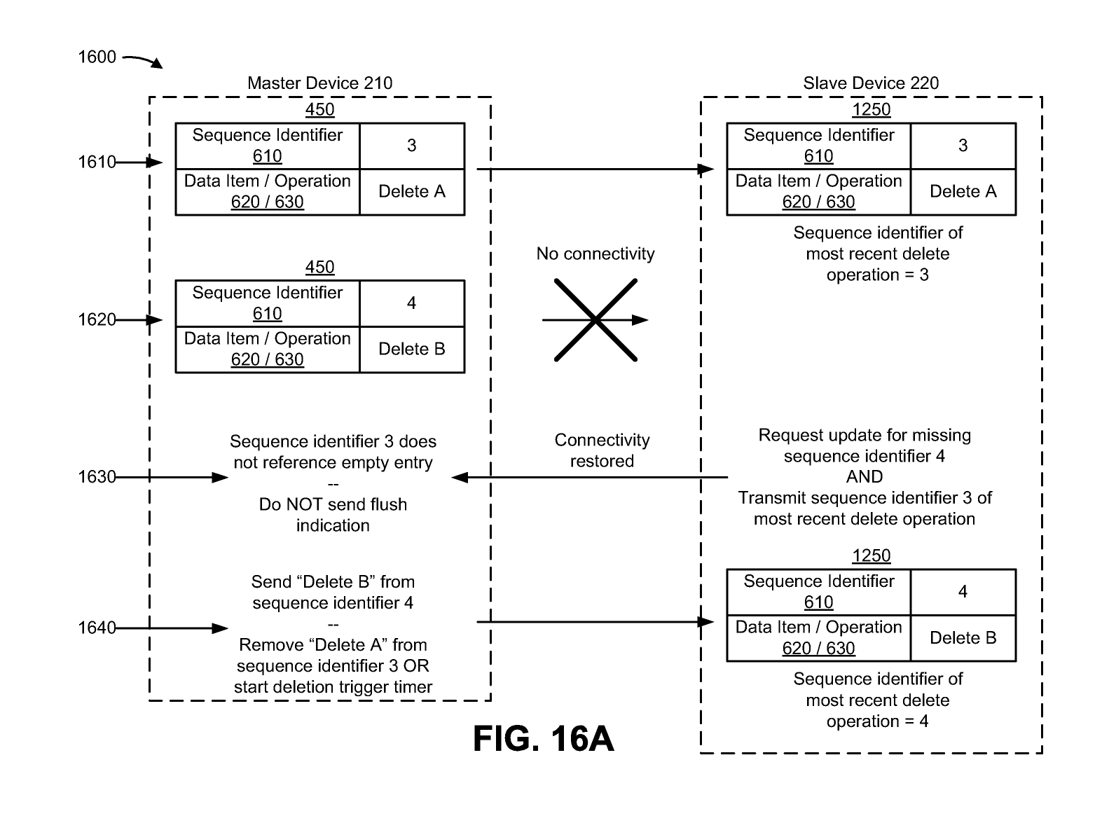

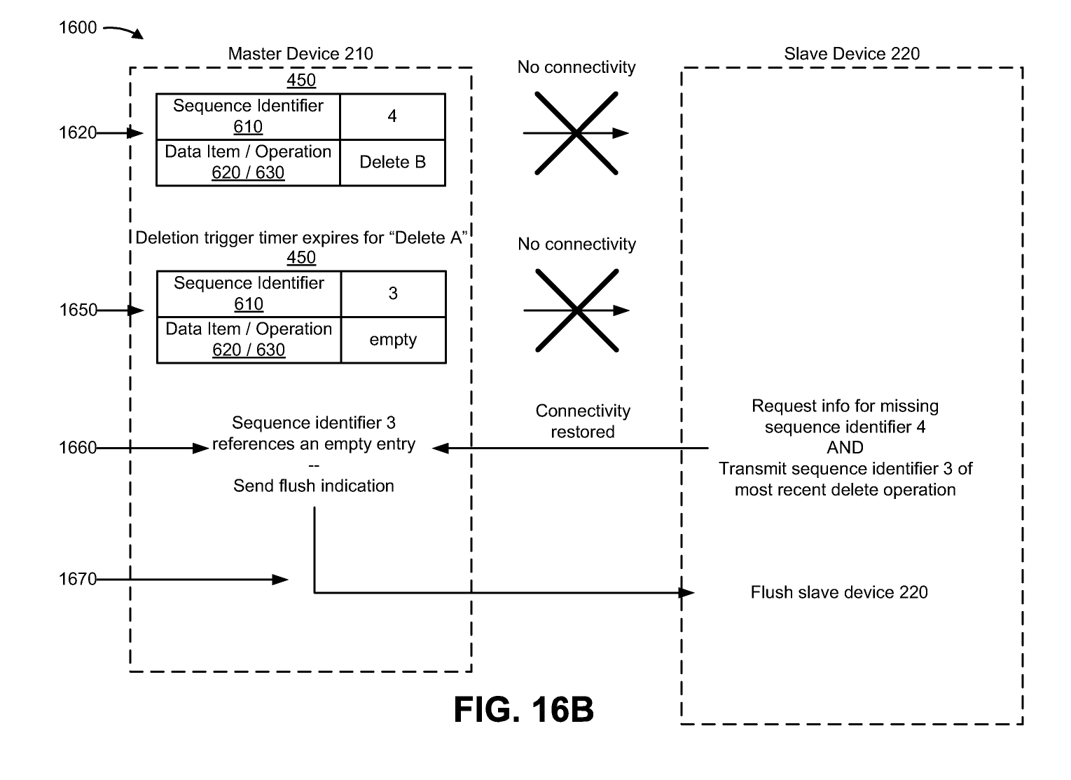

FIGS. 16A and 16B are diagrams of an example implementation 1600 relating to process 1500, illustrated in FIG. 15. FIG. 16A illustrates an implementation where slave device 220 is not flushed, and FIG. 16B illustrates an implementation where slave device 220 is flushed.

As illustrated in FIG. 16A, master device 210 may store information in data item sequence table 450, which may include sequence identifier field 610 (FIG. 6), data item identifier field 620 (FIG. 6), and operation identifier field 630 (FIG. 6). Furthermore, slave device 220 may store information in data item sequence table 1250, which may also include sequence identifier field 610 (FIG. 6), data item identifier field 620 (FIG. 6), and operation identifier field 630 (FIG. 6).

In implementation 1600, assume that master device 210 has received data item updates to add data items A and B, and data item sequence table 450 has been updated to include “Add A” at sequence identifier 1 and “Add B” at sequence identifier 2. Further assume that master device 210 has published the data item updates to slave device 220, and data item sequence table 1250 has been updated to include “Add A” at sequence identifier 1 and “Add B” at sequence identifier 2.

Reference number 1610 indicates that master device 210 may receive a data item update to delete data item A, and data item sequence table 450 may be updated to include “Delete A” at sequence identifier 3. Master device 210 may publish the data item update to slave device 220, which may store the update at sequence identifier 3, and may store sequence identifier 3 as referencing the most recent delete operation (e.g., the delete operation associated with the most recent sequence identifier and/or the highest sequence number).

Reference number 1620 indicates that master device 210 may receive a data item update to delete data item B, and data item sequence table 450 may be updated to include “Delete B” at sequence identifier 4. Master device 210 has lost connectivity with slave device 220, and “Delete B” is not transmitted to slave device 220.

Reference number 1630 indicates that connectivity has been restored between master device 210 and slave device 220. Slave device 220 may request a missing data item update referenced by missing sequence identifier 4, and may transmit, with the request, an indication of sequence identifier 3, which references the most recent delete operation stored in data item sequence table 1250 on slave device 220. Master device 210 may receive the request and the indication of sequence identifier 3, and may determine that sequence identifier 3 does not reference an empty entry. Based on the determination that sequence identifier 3 does not reference an empty entry, master device 210 may determine not to send a flush indication to slave device 220.

Reference number 1640 indicates that master device 210 may send “Delete B,” referenced by sequence identifier 4, to slave device 220. Slave device 220 may update data item sequence table 1250 with “Delete B” at sequence identifier 4, and may store sequence identifier 4 as referencing the most recent delete operation. In some implementations, master device 210 may remove “Delete A” from sequence identifier 3, so that sequence identifier 3 now references an empty entry. This may be done, for example, when there is a single slave device 220. In other implementations, master device 210 may retain “Delete A” in data item sequence table 450 until a deletion trigger timer has expired.

The information sent received, stored, and published by master device 210 and/or slave device 220, as indicated by reference numbers 1610-1640 and fields 610-630, is provided for explanatory purposes. In practice, master device 210 and/or slave device 220 may be associated with additional information, less information, different information, and/or differently arranged information than illustrated in FIG. 16A.

As illustrated in FIG. 16B, master device 210 may store information in data item sequence table 450, which may include sequence identifier field 610 (FIG. 6), data item identifier field 620 (FIG. 6), and operation identifier field 630 (FIG. 6). Furthermore, slave device 220 may store information in data item sequence table 1250, which may also include sequence identifier field 610 (FIG. 6), data item identifier field 620 (FIG. 6), and operation identifier field 630 (FIG. 6).

In implementation 1600, assume that master device 210 has received data item updates to add data items A and B, and data item sequence table 450 has been updated to include “Add A” at sequence identifier 1 and “Add B” at sequence identifier 2. Further assume that master device 210 has published the data item updates to slave device 220, and data item sequence table 1250 has been updated to include “Add A” at sequence identifier 1 and “Add B” at sequence identifier 2. Also assume that the events described in connection with reference number 1610 (FIG. 16A) have occurred, so that data item sequence table 1250 on slave device 220 has stored “Delete A” referenced by sequence identifier 3, and slave device 220 has stored sequence identifier 3 as referencing the most recent delete operation.

Reference number 1620 indicates that master device 210 may receive a data item update to delete data item B, and data item sequence table 450 may be updated to include “Delete B” at sequence identifier 4. Master device 210 has lost connectivity with slave device 220, and “Delete B” is not transmitted to slave device 220.

Reference number 1650 indicates that a deletion trigger timer has expired for “Delete A,” referenced by sequence identifier 3, and master device 210 has removed information referenced by sequence identifier 3 to create an empty entry in data item sequence table 450. Master device 210 and slave device 220 are still not connected.

Reference number 1660 indicates that connectivity has been restored between master device 210 and slave device 220. Slave device 220 may request a missing data item update referenced by missing sequence identifier 4, and may transmit, with the request, an indication of sequence identifier 3, which references the most recent delete operation stored in data item sequence table 1250 on slave device 220. Master device 210 may receive the request and the indication of sequence identifier 3, and may determine that sequence identifier 3 references an empty entry. Based on the determination that sequence identifier 3 references an empty entry, master device 210 may send a flush indication to slave device 220.

Reference number 1670 indicates that master device 210 may send a flush indication to slave device 220, and slave device 220 may receive the flush indication. Based on receiving the flush indication, slave device 220 may flush data item updates from a memory of slave device 220, and may remove all entries (including sequence identifiers) from data item sequence table 1250.

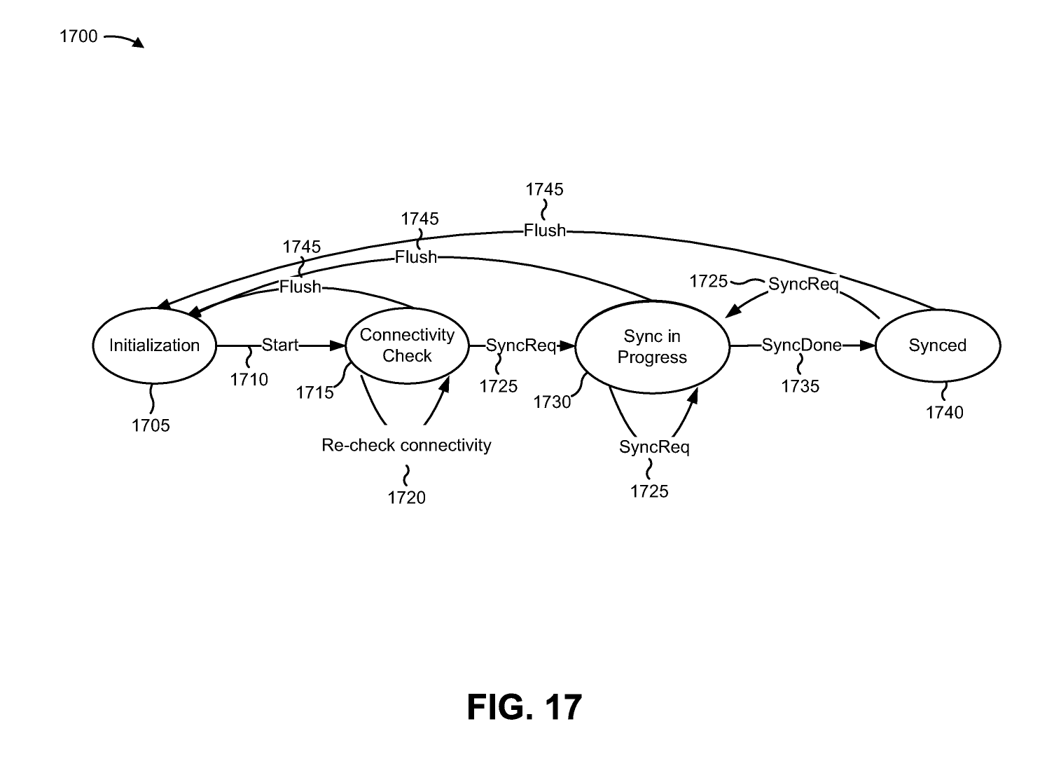

FIG. 17 is a diagram of example states and state transitions 1700 of slave device 220. As illustrated in FIG. 17, a state of slave device 220 may include an initialization state 1705, a connectivity check state 1715, a sync in progress state 1730, and a synced state 1740. As further illustrated in FIG. 17, a transition between states may be triggered by an event, including a start event 1710, a re-check connectivity event 1720, a sync request (“SyncReq”) event 1725, a sync done (“SyncDone”) event 1735, and a flush event 1745. In some implementations, states and state transitions 1705-1745 may apply to a single data set to be initialized, updated, and synchronized on slave device 220. Additionally, or alternatively, states and state transitions 1705-1745 may apply to multiple data sets.

Initialization state 1705 may indicate that slave device 220 is being initialized. For example, slave device 220 may be initialized by deleting a data set from slave device 220 (e.g., deleting all data items 1240 in the data set, and all data item information in the data set). In some implementations, slave device 220 may be initialized by setting all data item attributes to a default value (e.g., a null value). Initialization state 1705 may be triggered by flush event 1745, may be triggered by data set registration, and/or may be triggered when slave device 220 is powered up and/or restarted.

Start event 1710 may transition slave device 220 from initialization state 1705 to connectivity check state 1715. In some implementations, start event 1705 may be triggered after initialization of slave device 220. Additionally, or alternatively, start event 1705 may be triggered by flush event 1745, by data set registration, by powering up of slave device 220 and/or by restarting slave device 220.

Connectivity check state 1715 may indicate that slave device 220 is checking connectivity between slave device 220 and master device 210. In some implementations, slave device 220 may determine that master device 210 is powered up, that slave device 220 is able to communicate with master device 210, and/or that master device 210 is able to communicate with slave device 220. For example, slave device 220 may ensure that push and/or pull communications between slave device 220 and master device 210 are enabled.

In some implementations, slave device 220 may transmit an echo request to master device 210 that includes a location identifier that identifies a destination address and/or location for communications with slave device 220. Slave device 220 may also start an echo retransmit timer when transmitting the echo request. Master device 210 may receive the echo request, and may send an echo response to slave device 220. In some implementations, master device 210 may send an echo response to a set of slave devices 220 (e.g., all slave devices 220 in a distributed computing environment). The echo response may include a location identifier for each location identifier received by master device 210. When slave device 220 receives an echo response with the location identifier for slave device 220, slave device 220 may determine that the connectivity check was successful, which may trigger sync request event 1725. If the echo retransmit timer expires before an echo request is received by slave device 220, slave device 220 may trigger re-check connectivity event 1720.

Re-check connectivity event 1720 may be triggered when an echo retransmit timer expires before an echo response to an echo request from slave device 220 is received. Re-check connectivity event 1720 may trigger connectivity check state 1715, which may cause slave device 220 to re-check connectivity with master device 210 by sending another echo request and starting another echo retransmit timer.

Sync request event 1725 may transition slave device 220 from connectivity check state 1715 to sync in progress state 1730. In some implementations, sync request event 1725 may be triggered by a successful connectivity check (e.g., when slave device 220 receives an echo response before expiration of the echo retransmit timer). Additionally, or alternatively, sync request event 1725 may be triggered during sync in progress state 1730 or synced state 1740. For example, sync request event 1725 may be triggered when slave device 220 determines that slave device 220 is missing a data item update from master device 210.

Sync in progress state 1730 may indicate that slave device 220 is being updated with data item updates. For example, sync in progress state 1730 may include receiving, by slave device 220, a data item update from master device 210. Additionally, or alternatively, sync in progress state 1730 may include requesting, by slave device 220, a missing data item update from master device 210. Slave device 220 may remain in sync in progress state 1730 until a list of missing data item updates, stored by slave device 220, is empty.

Sync done event 1735 may transition slave device 220 from sync in progress state 1730 to synced state 1740. In some implementations, sync done event 1735 may be triggered when slave device 220 determines that it is not missing any data item updates from master device 210. For example, sync done event 1735 may be triggered when a list of missing data item updates, stored by slave device 220, is empty.

Synced state 1740 may indicate that slave device 220 is synchronized with master device 210. For example, synced state 1740 may indicate that a data set stored on slave device 220 matches a corresponding data set stored on master device 210.

Flush event 1745 may transition slave device 220 from connectivity check state 1715, sync in progress state 1730, or synced state 1740, to initialization state 1705. In some implementations, flush event 1745 may cause slave device 220 to be initialized (e.g., to delete all data items 1240 in a data set indicated by the flush event, and to delete all data item information in the data set). In some implementations, flush event 1745 may be triggered when master device 210 is restarted. Restarting master device 210 may cause all data sets stored by slave device 220 to be flushed. Additionally, or alternatively, flush event 1745 may be triggered for a particular data set when master device 210 determines that there is a stale data item in the particular data set (e.g., that a sequence identifier of a most recent delete operation, received from slave device 220, references an empty entry on master device 210, discussed herein in connection with FIG. 15).

Implementations described herein may assist in synchronizing devices in a distributed computing environment (such as master devices and slave devices) so that a local memory of each device stores updated information.

The foregoing disclosure provides illustration and description, but is not intended to be exhaustive or to limit the embodiments to the precise form disclosed. Modifications and variations are possible in light of the above disclosure or may be acquired from practice of the embodiments.

As used herein, the term “component” is intended to be broadly construed as hardware, firmware, or a combination of hardware and software.

Some implementations are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold,” “being less than a threshold,” “being less than or equal to a threshold,” or other similar terms.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive information that identifies a data item;
receive information that identifies an operation to perform on the data item, the operation comprising at least one of an add operation, a modify operation, or a delete operation;
store, in a memory, a first sequence identifier, a data item reference that references the data item, and an operation reference that references the operation, the first sequence identifier referencing the data item reference and the operation reference and indicating an order in which the first sequence identifier is stored;
determine that the operation is one of the add operation, the modify operation, or the delete operation;
if the operation is the add operation:
store the data item in the memory at a first memory location; and
associate information that identifies the first memory location with the first sequence identifier;
if the operation is the modify operation:
modify the data item in the memory to create a modified data item;
store the modified data item in the memory at a second memory location;
associate information that identifies the second memory location with the first sequence identifier; and
remove, from the memory, a first reference to the data item by a first previous sequence identifier that references the data item, the first previous sequence identifier being stored before the first sequence identifier; and
if the operation is the delete operation:
delete the data item from the memory; and
remove, from the memory, a second reference to the data item by a second previous sequence identifier that references the data item, the second previous sequence identifier being stored before the first sequence identifier; and
transmit, to a slave device, the first sequence identifier, the data item reference, and the operation reference.

2. The device of claim 1, where the operation is the delete operation, and the one or more processors are further to:
receive a deletion trigger, the deletion trigger indicating that an amount of time that has passed, since the first sequence identifier was stored, satisfies a threshold; and
remove, from the memory, the first sequence identifier, the data item reference, and the operation reference.

3. The device of claim 1, where the one or more processors are further to:
determine a most recently transmitted sequence identifier; and
where the one or more processors, when transmitting the first sequence identifier, are further to:
transmit the first sequence identifier based on the most recently transmitted sequence identifier, the first sequence identifier being stored in the memory after the most recently transmitted sequence identifier.

4. The device of claim 3, where the one or more processors are further to:
determine a plurality of sequence identifiers stored in the memory after the most recently transmitted sequence identifier;
determine a set of sequence identifiers, of the plurality of sequence identifiers, based on a quantity of the plurality of sequence identifiers satisfying a threshold; and
where the one or more processors, when transmitting the first sequence identifier, are further to:
transmit, to the slave device, the set of sequence identifiers, a data item referenced by each of the set of sequence identifiers, and an operation referenced by each of the set of sequence identifiers.

5. The device of claim 1, where the one or more processors are further to:
receive a request, from the slave device, that identifies one or more sequence identifiers; and
where the one or more processors, when transmitting the first sequence identifier, are further to:
transmit the first sequence identifier based on the first sequence identifier being identified in the request.

6. The device of claim 5, where the slave device is further to:
receive a first indication of a first most recently transmitted sequence identifier;
receive a second indication of a second most recently transmitted sequence identifier, the second indication being received after the first indication;
determine the one or more sequence identifiers based on the first most recently transmitted sequence identifier and the second most recently transmitted sequence identifier.

7. The device of claim 1, where the one or more processors are further to:
receive, from the slave device, a second sequence identifier;
determine that the second sequence identifier references an empty entry; and
send, based on the determination, a flush indication to the slave device, where the flush indication causes the slave device to delete all sequence identifiers from a memory of the slave device.

8. A computer-readable medium for storing instructions, the instructions comprising:
one or more instructions that, when executed by a processor, cause the processor to:
receive information that identifies a data item;
receive information that identifies an operation to perform on the data item, the operation comprising at least one of an add operation, a modify operation, or a delete operation;
store, in a memory, a first sequence identifier, a data item reference that references the data item, and an operation reference that references the operation, the first sequence identifier referencing the data item reference and the operation reference and indicating an order in which the first sequence identifier is stored;
determine that the operation is one of the add operation, the modify operation, or the delete operation;
if the operation is the add operation:
store the data item in the memory at a first memory location; and
associate information that identifies the first memory location with the first sequence identifier;
if the operation is the modify operation:
modify the data item in the memory to create a modified data item;
store the modified data item in the memory at a second memory location;
associate information that identifies the second memory location with the first sequence identifier; and
remove, from the memory, a first reference to the data item by a first previous sequence identifier that references the data item, the first previous sequence identifier being stored before the first sequence identifier; and
if the operation is the delete operation:
delete the data item from the memory; and
remove, from the memory, a second reference to the data item by a second previous sequence identifier that references the data item, the second previous sequence identifier being stored before the first sequence identifier; and
transmit, to a slave device, the first sequence identifier, the data item reference, and the operation reference.

9. The computer-readable medium of claim 8, where the operation is the delete operation, and the one or more instructions further cause the processor to:
receive a deletion trigger, the deletion trigger indicating that an amount of time that has passed, since the first sequence identifier was stored, satisfies a threshold; and
remove, from the memory, the first sequence identifier, the data item reference, and the operation reference.

10. The computer-readable medium of claim 8, where the one or more instructions further cause the processor to:
determine a most recently transmitted sequence identifier; and
where the one or more instructions, when causing the processor to transmit the first sequence identifier, further cause the processor to:
transmit the first sequence identifier based on the most recently transmitted sequence identifier, the first sequence identifier being stored in the memory after the most recently transmitted sequence identifier.

11. The computer-readable medium of claim 10, where the one or more instructions further cause the processor to:
determine a plurality of sequence identifiers stored in the memory after the most recently transmitted sequence identifier;
determine a set of sequence identifiers, of the plurality of sequence identifiers, based on a quantity of the plurality of sequence identifiers satisfying a threshold; and
where the one or more instructions, when causing the processor to transmit the first sequence identifier, further cause the processor to:
transmit, to the slave device, the set of sequence identifiers, a data item referenced by each of the set of sequence identifiers, and an operation referenced by each of the set of sequence identifiers.

12. The computer-readable medium of claim 8, where the one or more instructions further cause the processor to:
receive a request, from the slave device, that identifies one or more sequence identifiers; and
where the one or more instructions, when causing the processor to transmit the first sequence identifier, further cause the processor to:
transmit the first sequence identifier based on the first sequence identifier being identified in the request.

13. The computer-readable medium of claim 12, where the one or more instructions further cause the processor to:
transmit a first indication of a first most recently transmitted sequence identifier; and
transmit a second indication of a second most recently transmitted sequence identifier, the second indication being transmitted after the first indication;
the first indication and the second indication allowing the slave device to determine the one or more sequence identifiers based on the first most recently transmitted sequence identifier and the second most recently transmitted sequence identifier.

14. The computer-readable medium of claim 8, where the one or more one or more instructions further cause the processor to:
receive, from the slave device, a second sequence identifier;
determine that the second sequence identifier references an empty entry; and
send, based on the determination, a flush indication to the slave device, where the flush indication causes the slave device to delete all sequence identifiers from a memory of the slave device.

15. A method, comprising:
receiving, by a master device, information that identifies a data item;
receiving, by the master device, information that identifies an operation to perform on the data item, the operation comprising a modify operation;
storing, in a memory of the master device, a first sequence identifier, a data item reference that references the data item, and an operation reference that references the operation, the first sequence identifier referencing the data item reference and the operation reference and indicating an order in which the first sequence identifier is stored;
determining, by the master device, that the operation is the modify operation;
modifying, by the master device, the data item in the memory to create a modified data item;
storing, by the master device, the modified data item in the memory at a memory location;
associating, by the master device, information that identifies the memory location with the first sequence identifier; and
removing, from the memory of the master device, a reference to the data item by a first previous sequence identifier that references the data item, the first previous sequence identifier being stored before the first sequence identifier; and
transmitting, by the master device and to a slave device, the first sequence identifier, the data item reference, and the operation reference.

16. The method of claim 15, further comprising:
determining a most recently transmitted sequence identifier; and
where transmitting the first sequence identifier further comprises:
transmitting the first sequence identifier based on the most recently transmitted sequence identifier, the first sequence identifier being stored in the memory after the most recently transmitted sequence identifier.

17. The method of claim 16, further comprising:
determining a plurality of sequence identifiers stored in the memory after the most recently transmitted sequence identifier;
determining a set of sequence identifiers, of the plurality of sequence identifiers, based on a quantity of the plurality of sequence identifiers satisfying a threshold; and
where transmitting the first sequence identifier further comprises:
transmitting, to the slave device, the set of sequence identifiers, a data item referenced by each of the set of sequence identifiers, and an operation referenced by each of the set of sequence identifiers.

18. The method of claim 15, further comprising:
receiving a request, from the slave device, that identifies one or more sequence identifiers; and
where transmitting the first sequence identifier further comprises:
transmitting the first sequence identifier based on the first sequence identifier being identified in the request.

19. The method of claim 18, further comprising:
transmitting a first indication of a first most recently transmitted sequence identifier; and
transmitting a second indication of a second most recently transmitted sequence identifier, the second indication being transmitted after the first indication;
the first indication and the second indication allowing the slave device to determine the one or more sequence identifiers based on the first most recently transmitted sequence identifier and the second most recently transmitted sequence identifier.

20. The method of claim 15, further comprising:
receiving, from the slave device, a second sequence identifier;
determining that the second sequence identifier references an empty entry; and
sending, based on the determination, a flush indication to the slave device, where the flush indication causes the slave device to delete all sequence identifiers from a memory of the slave device.
